(19) United States
(12) Patent Application Publication
(10) Pub. No.: US 2011/0215998 A1
(43) Pub. Date: Sep. 8, 2011

(54) PHYSICAL ACTION LANGUAGES FOR DISTRIBUTED TANGIBLE USER INTERFACE SYSTEMS

(76) Inventors: Brent Paul FITZGERALD, San Francisco, CA (US); Jeevan James KALANITHI, San Francisco, CA (US); David Jeffrey MERRILL, San Francisco, CA (US)

(21) Appl. No.: 13/041,657

(22) Filed: Mar. 7, 2011

Related U.S. Application Data
(60) Provisional application No. 61/311,716, filed on Mar. 8, 2010.
(60) Provisional application No. 61/429,420, filed on Jan. 3, 2011.

(51) Int. Cl. G09G 5/00

(52) U.S. Cl. 345/156

(57) ABSTRACT

A system and a method are disclosed for a software configuration for use with distributed tangible user interfaces, in which the software is manipulated via a set of individual actions on individual objects, and in which such individual actions across one or more objects may be combined, simultaneously and/or over time, resulting in compound actions that manipulate the software. These actions and compound actions may be interpreted and acted upon by the software differently depending on its design, configuration, and internal state.

### RELATED APPLICATION

The present application relates to and claims the benefit of priority to U.S. Provisional Patent Application No. 61/311,716 filed 8 Mar., 2010 and U.S. Patent Provisional Patent Application No. 61/429,420 filed 1 Jan., 2011 which is hereby incorporated by reference in its entirety for all purposes as if fully set forth herein.

### BACKGROUND OF THE INVENTION

1. Field of the Invention

The disclosure generally relates to the field of computer interaction, and more particularly to the field of physical interfaces with computer interaction.

2. Relevant Background

The interaction between computing devices and users continues to improve as computing platforms become more powerful and able to respond to a user in many new and different ways, so that a user is not required to type on a keyboard in order to control applications and input data. The development of a user interface system has greatly improved the ease with which a user can interact with a computing device by enabling a user to input control actions and make selections in a more natural and intuitive manner.

The ease with which a user can input control actions is particularly important in electronic games and other virtual environments, because of the need to provide input quickly and efficiently. Users typically interact with virtual environments by manipulating a mouse, joystick, wheel, game pad, track ball, or other user input device to carry out some function as defined by a software program.

Another form of user input employs displays that are responsive to the touch of a user's finger or a stylus. Touch responsive displays can be pressure activated, respond to electrical capacitance or changes in magnetic field intensity, employ surface acoustic waves, or respond to other conditions that indicate the location of a finger or stylus on the display. Another type of touch sensitive display includes a plurality of optical sensors that are spaced apart around the periphery of the display screen so that the location of a finger or stylus touching the screen can be detected. Using one of these touch sensitive displays, a user can more directly control a virtual object that is being displayed. For example, the user may touch the displayed virtual object with a finger to select the virtual object and then drag the selected virtual object to a new position on the touch-sensitive display.

Capacitive, electromagnetic, optical, or other types of sensors used in conventional touch-sensitive displays typically cannot simultaneously detect the location of more than one finger or object touching the display screen at a time. Capacitive, resistive, or acoustic surface wave sensing display surfaces that can detect multiple points of contact are unable to image objects on a display surface with any degree of resolution. And prior art systems of these types cannot detect patterns on an object or detailed shapes that might be used to identify each object among a plurality of different objects that are placed on a display surface.

Because applications of the human computer interface are widely applied in many different fields, a gesture recognition approach is widely sought after. Moreover, the gesture-based input interface is a more natural and direct human computer interface.

In the field of interactive computer software and systems, there are a variety of patterns and methodologies employed to allow a user to understand and interact with the software via physical inputs and outputs. Lacking in each of these approaches is the ability to physically interact with and manipulate a plurality of input devices that can individually detect proximity and orientation so as to provide to the user the ability to interface with a computer system using a gesture language.

### SUMMARY OF THE INVENTION

Physical action languages used in conjunction with a distributed tangible user interface enables a user to interface with a computer using physically manipulable objects. Upon the detection of physical interaction with one or more physically manipulable objects a determination is made whether the identified physical action matches a predefined action parameter. When the physical interaction matches the predetermined parameters software elements associated with the physically manipulable objects that detected the physical interaction are updated.

According to one embodiment of the present invention the physically manipulable objects operate independent of each other and include a plurality of sensors operative to detect any physical interaction. Among other things these manipulable objects include motion and proximity sensors as well as the ability to render feedback to the user via visual and auditory means.

Upon detection of a physical interaction and according to one embodiment of the present invention, the physically manipulable objects wirelessly convey data regarding the physical interaction to a software architecture. In one version of the invention the architecture is resident on a host computer while in another the software architecture is distributed among the objects and in yet another embodiment the software architecture is distributed among a host computer and the objects. This architecture is operable to process the physical interaction and determine whether a predetermined action parameter has been achieved.

According to one embodiment of the present invention the physical interaction of the one or more physically manipulable objects includes, among others, a touch, motion, location alteration, or a compound event. A touch event can include a touch, a touch release, a combined touch and release, a surface touch and drag, or a touch-release-touch event. The physical interaction can also include multiple physical interactions with two or more physically manipulable objects simultaneously or within a predetermined window of time.

Other types of physical interactions contemplated by the present invention includes motion events such as tilting, shaking, translating or moving, and rotating a manipulable physical object either in one plane or flipping the objects through multiple planes. Indeed the present invention contemplates a physical interaction to include multiple combinations of events.

In addition other embodiments of the present invention address physical interaction to include location altering events. In such a situation the location of one or more physically manipulable objects is altered. The present invention examines the location altering data to determine whether one or more objects are either rendered closer in proximity to each other or separated from each other. In the instance in which the objects are moved to be in closer proximity to each other the present invention determines whether a new group of objects has been formed or whether the newly added object(s) is merely merged into an existing group. Likewise, when object(s) are moved away from an existing group the invention determines whether two new groups have been created.

Another physical interaction addressed by the present invention includes compound events or an interaction that triggers two or more sensors. Compound events can include multiple events on a single object, substantially simultaneous events on a plurality of objects or any combination thereof. According to one embodiment of the present invention compound events can include any of several touch events combined with any of several motion events. Likewise other compound events can include any of several motion events combined with any of several location altering events. As will be apparent to one skilled in the relevant art any of the above mentioned events can be combined to form numerous permutations, all of which are contemplated by the present invention.

According to another embodiment of the present invention a computer-readable storage medium embodies a program of instructions that includes a plurality of program codes. These program codes are operative for using a plurality of physically manipulable objects to interface with a computer system. Once such program code detects physical interaction with one or more physically manipulable objects, another program code conveys data with respect to that physical interaction to a software architecture. There processing occurs using yet another program code to determine whether the physical interactions match a predetermined action parameter. Should an action parameter be matched, another program code is operative to update a software element corresponding to the one or more of the physically manipulable objects and, in some embodiments, rendering feedback to the user.

As with the previous embodiments a plurality of physical interaction can occur with one or more physically manipulable objects either singularly or in combination. Indeed multiple permutations of combined physical interactions and action events is contemplated and addressed by embodiments of the present invention.

Another aspect of the present invention includes a distributed tangible user interface system comprising a plurality of physically manipulable objects wherein each object includes a plurality of sensors. These sensors can detect, among other things, touch, motion, surface contact, location alterations and proximity to other objects.

The system further includes, according to one embodiment, a host computer on which a software architecture resides. In one version of the present invention physical interaction with one or more of the physically manipulable objects is communicated to the software architecture resident on the host wherein software portions determine whether the physical interaction matches a predetermined action parameter. Based on this analysis an action event such as a touch, motion, location alteration, or any combination thereof can be declared. Once declared another software portion updates elements associated with the physically manipulable objects corresponding to the detected physical interactions.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a perspective view of an example distributed tangible user interface, composed of individual physical objects;

FIG. 2 is a perspective view showing the user depressing pushbutton sensor input on two objects with a triangle visual indicator displayed on integrated display;

FIG. 3 is a perspective view showing the user not depressing pushbutton sensor input on two objects;

FIG. 4 is a perspective view showing the user depressing pushbutton sensor input on two objects while both objects are arranged adjacent to one another, and with circle visual indicators displayed on integrated display;

FIG. 5 is a perspective view showing a user performing a button press on an individual object within a distributed tangible user interface, an example of a touch action;

FIG. 6 is a perspective view showing a user performing a button release on an individual object within a distributed tangible user interface, an example of a touch action;

FIG. 7 is a perspective view showing a user performing a button click (press and release) on an individual object within a distributed tangible user interface, an example of a touch action;

FIG. 8 is a perspective view showing a user performing a double button click (press and release, then another press and release) on an individual object within a distributed tangible user interface, an example of a touch action;

FIG. 9 is a diagram demonstrating how the software architecture recognizes and processes release events on objects;

FIG. 10 is a diagram demonstrating how the software architecture recognizes and processes press and release events on objects;

FIG. 11 is a diagram demonstrating how the software architecture recognizes and processes double press and release events on objects;

FIG. 12 is a perspective view showing a user performing a surface touch (“dab”) on an individual object within a distributed tangible user interface, an example of a touch action;

FIG. 13 is a perspective view showing a user performing a surface touch and drag on an individual object within a distributed tangible user interface, an example of a touch action;

FIG. 14 is a perspective view showing a user performing multiple surface touches and drags on an individual object within a distributed tangible user interface, an example of a touch action;

FIG. 15 is a diagram demonstrating how the software architecture recognizes and processes touch events on objects;

FIG. 16 is a diagram demonstrating how the software architecture recognizes and processes touch and drag events on objects;

FIG. 17 is a diagram demonstrating how the software architecture recognizes and processes multiple touch and drag events on objects;

FIG. 18 is a perspective view showing a user tilting an individual object within a distributed tangible user interface, an example of a motion action;

FIG. 19 is a perspective view showing a user shaking an individual object within a distributed tangible user interface, an example of a motion action;

FIG. 20 is a perspective view showing a user sliding an individual object within a distributed tangible user interface, an example of a motion action;

FIG. 21 is a perspective view showing a user flipping over an individual object within a distributed tangible user interface, an example of a motion action;

FIG. 22 is a diagram demonstrating how the software architecture recognizes and processes tilt events of objects;

FIG. 23 is a diagram demonstrating how the software architecture recognizes and processes shake events of objects;

FIG. 24 is a diagram demonstrating how the software architecture recognizes and processes slide events of objects;

FIG. 25 is a diagram demonstrating how the software architecture recognizes and processes flip events of objects;

FIG. 26 is a perspective view showing a user moving two objects to be adjacent to one another within a distributed tangible user interface, an example of an arrangement action;

FIG. 27 is a perspective view showing a user adding an object to a group by moving it to be adjacent with two members of a group demonstrating an arrangement action within a distributed tangible user interface;

FIG. 28 is a perspective view showing a user moving two objects to be adjacent to two other objects in order to create a group, an example of an arrangement action within a distributed tangible user interface;

FIG. 29 is a perspective view showing a user moving two objects away from other objects in order to separate one group into two groups demonstrating an arrangement action within a distributed tangible user interface;

FIG. 30 is a perspective view showing a user using one object to push another in order to add both to an existing sequence of objects demonstrating an arrangement action within a distributed tangible user interface;

FIG. 31 is a perspective view showing a user inserting one object between other objects, thereby turning three groups into one, and creating a single sequence demonstrating an arrangement action within a distributed tangible user interface;

FIG. 32 is a perspective view showing a user stacking one object on top of other objects, an example of an arrangement action within a distributed tangible user interface;

FIG. 33 is a perspective view showing a user stacking one object on top of other objects (in a vertical orientation), an example of an arrangement action within a distributed tangible user interface;

FIG. 34 is a diagram demonstrating how the software architecture recognizes and processes object adjacency on objects;

FIG. 35 is a perspective view showing the user moving an object 10 to be adjacent to a stationary object within a distributed tangible user interface, an example of an arrangement action;

FIG. 36 is a diagram demonstrating how the software architecture recognizes and processes adjacency events, particularly as it pertains to creating groups of software elements that correspond to objects;

FIG. 37 is a diagram demonstrating how the software architecture recognizes and processes additions to groups of objects;

FIG. 38 is a diagram demonstrating how the software architecture recognizes and processes multiple object adjacency;

FIG. 39 is a diagram demonstrating how the software architecture recognizes and processes multiple object removal;

FIG. 40 is a diagram demonstrating how the software architecture recognizes and processes additions to a sequence of objects;

FIG. 41 is a diagram demonstrating how the software architecture recognizes and processes insertion into a sequence of objects;

FIG. 42 is a diagram demonstrating how the software architecture recognizes and processes stacking of objects;

FIG. 43 is a diagram demonstrating how the software architecture recognizes and processes stacking (vertically) of objects;

FIG. 44 is a perspective view showing a user simultaneously depressing two buttons (touch action) on one object demonstrating a single object compound action within a distributed tangible user interface;

FIG. 45 is a perspective view showing a user simultaneously depressing a button (touch action) while tilting (motion action) one object demonstrating a single object compound action within a distributed tangible user interface;

FIG. 46 is a perspective view showing a user simultaneously depressing a button (touch action) while shaking (motion action) one object demonstrating a single object compound action within a distributed tangible user interface;

FIG. 47 is a diagram demonstrating how the software architecture recognizes and processes simultaneous press events on objects;

FIG. 48 is a diagram demonstrating how the software architecture recognizes and processes simultaneous press and tilt events with objects;

FIG. 49 is a diagram demonstrating how the software architecture recognizes and processes simultaneous shake and press events with objects;

FIG. 50 is a perspective view showing a user depressing a button (touch action) on each of two objects while moving each object to be adjacent to the other (arrangement action) demonstrating a multi-object compound action within a distributed tangible user interface;

FIG. 51 is a perspective view showing a user tilting an object (motion action) while moving it to be adjacent to another object (arrangement action) demonstrating a simultaneous multi-object compound action within a distributed tangible user interface;

FIG. 52 is a perspective view showing a user simultaneously tilting two adjacent objects (motion action) towards one another demonstrating a simultaneous multi-object compound action within a distributed tangible user interface;

FIG. 53 is a perspective view showing a user moving an object away from a certain side of another object (arrangement action) to a different side of the same object (arrangement action) demonstrating a sequential multi-object compound action within a distributed tangible user interface;

FIG. 54 is a perspective view showing a user moving one object to be adjacent to second object (arrangement action), depressing the button on the second object (touch action), and moving the first object away from the second (arrangement action) demonstrating a sequential multi-object compound action within a distributed tangible user interface;

FIG. 55 is a diagram demonstrating how the software architecture recognizes and processes simultaneous press and adjacency events with objects;

FIG. 56 is a diagram demonstrating how the software architecture recognizes and processes tilt and adjacency events with objects;

FIG. 57 is a diagram demonstrating how the software architecture recognizes and processes simultaneous tilting events of objects;

FIG. 58 is a diagram demonstrating how the software architecture recognizes and processes switching of adjacency events with objects;

FIG. 59 is a diagram demonstrating how the software architecture recognizes and processes sequential adjacency, touch, and removal events on objects;

FIG. 60 is a diagram demonstrating how the software architecture recognizes and processes touch events on objects;

FIG. 61 is a perspective view showing the user depressing a pushbutton sensor input on an object resulting in a visual cue on display surface of another object, indicating to the user that further action is possible;

FIG. 62 is a perspective view, showing the result of moving an object with button depressed as described above, towards another object with visual cue on display surface resulting in an arrangement action, which in turn triggers a confirmation visual display on the object display surface;

FIG. 63 is a diagram demonstrating how the software architecture recognizes and processes press events on objects with a visual display;

FIG. 64 is a diagram demonstrating how the software architecture recognizes and processes press and adjacency events on objects with a visual display;

FIG. 65 is a diagram demonstrating how the software architecture recognizes and processes adjacency events on objects without a visual display;

FIG. 66 is a high-level block diagram illustrating an example computer that can be used to implement the software system described herein in accordance with an embodiment of the invention; and

FIG. 67 is a block diagram of the software architecture, demonstrating how user actions on the objects are aggregated, classified, and made available to an application running on top of the system.

The Figures depict embodiments of the present invention for purposes of illustration only. It is noted that wherever practicable similar or like reference numbers may be used in the figures and may indicate similar or like functionality. One skilled in the art will readily recognize from the following description that alternative embodiments of the structures and methods illustrated herein may be employed without departing from the principles described herein.

### DESCRIPTION OF THE INVENTION

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Described hereafter by way of example are computer-implemented methods, computer systems, and computer program products that allow interaction of a computing system with a distributed, tangible user interface; the interface comprising one or more physically manipulable objects that may be used singularly or in combination with other such objects. Such a system may be implemented in myriad ways. Given such a distributed tangible user interface, the software system is manipulated via a set of individual actions on individual objects, and in which such individual actions may be combined across one or more objects, simultaneously and/or over time, resulting in compound actions that manipulate the software. These actions and compound actions may be interpreted by the software differently depending on the configuration and state of the manipulable objects. Moreover, the resulting manipulation of the software system causes further actions that can either be perceived by a user, or causes a transformation in the physically manipulable objects themselves, or in an external system or an external object distinct from the physically manipulable objects.

According to one embodiment of the present invention interfaces can use one or more physical objects with gestural physical input. These systems can be referred to as distributed tangible user interfaces. For such systems comprised of interchangeable objects that are physically manipulated, there is a need for standardized software design solutions. These solutions form the basis of interaction and software frameworks for implementation of software requiring sophisticated physical input on such systems. Additionally, existing actions used in other interface systems (such as a mouse-driven GUI's “click,” “double click,” or “drag and drop”) do not apply to a computing interface comprising a set of graspable objects. Each object in a set of graspable objects (the interface) acts as input such that there may be no single input device but where inputs and actions of another object(s) may be useful to forming the interface. Such wireless, distributed, tangible interfaces require a unique language of physical actions and system responses as well as a software system for enabling such an action language. The system and methods disclosed herein are operable to identify user actions and gestures on objects in a distributed tangible interface and map these actions to changes in state or behavior of a computer program.

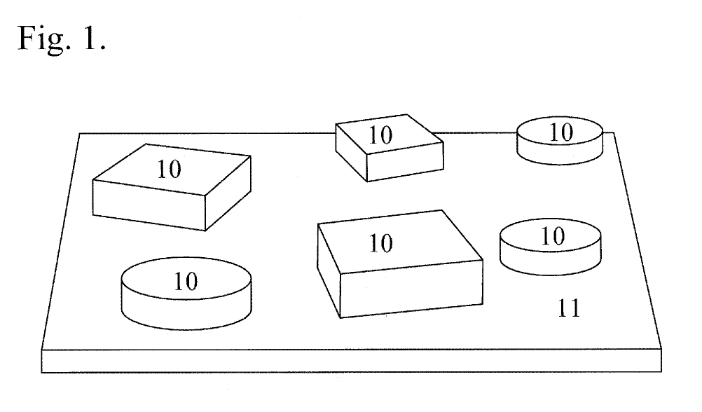

FIG. 1 shows an interface according to one embodiment of the present invention comprised of a set of physical objects 10 on a playing surface 11, each equipped with one or more input sensors. Examples of physical objects include, but are not limited to: blocks, tiles, cubes, spheres, hexagons, or more complex shapes and objects. Examples of input sensors include, but are not limited to: acceleration/tilt sensors, gyroscopic sensors, magnetic compass, clickable buttons, capacitive touch sensors, potentiometers, temperature sensors, motion sensors, light or image sensors, magnetic field sensors, sonic or ultrasonic sensors, or any other element that may be triggered or affected by physical, chemical, or electrical interaction. In the context of the present invention a triggering event or triggered sensor is an action that is perceptible by an applicable sensing device. For example the triggering of a touch sensor would be a touch of sufficient pressure, duration or other physical parameter that would result in the sensor being activated. Similarly a motion detection sensor would be triggered when the device was moved a sufficient amount such that the motion sensor registered the movement and generated data regarding the motion that can be examined to determine whether it rises to the level of an event.

In one embodiment, a physical implementation of a distributed tangible user interface comprises a set of compact manipulable tiles or devices, each tile including a microcontroller, battery, a feedback mechanism (such as a display or auditory generator) accelerometer sensor, onboard memory, button/click sensor, and sensors for detecting nearby tiles (such as radio, sonic, ultrasonic, visible light, infrared, image-based (camera) capacitive, magnetic, inductive or electromechanical contact sensors). In this example of a distributed tangible interface, triggering of these input sensors is interpreted to direct or influence the state or behavior of the controlling software system. In one embodiment, the software architecture resides on a host tile or other host computer. Each tile (also referred to herein as a graspable or manipulable object) reports sensor input events to the host and/or to other tiles via radio or other means. Other tiles can process some of the sensor input events into higher-order formulations, either to trigger immediate feedback on the tiles or for transmission to the software architecture on the host. The software architecture processes these formulations and/or sensor inputs into higher-order actions. This architecture allows actions performed by a user on an object to trigger state or behavior changes on the tiles and in the software architecture, including but not limited to executing subroutines or modifying locally or remotely stored variables or data.

One aspect of the present invention is that each tile or graspable object forming the distributed computer interface is aware of the presence and position of the other tiles. A tile can detect nearby tiles by a variety of means including, but are not limited to, proximity-detection and absolute position sensing. To detect proximity, a number of different methods may be used, including but not limited to light-based (i.e. edges of tiles have a transmitter and receiver for visible or near-visible light that is transmitted by one tile and received by the other), capacitive (i.e. edges of tiles have an antenna that is modulated by an electric signal, which induces a corresponding electric signal in a similar antenna on a neighboring tile), inductive (i.e. edges of tiles have a wound metal coil that generates a modulated electro-magnetic field unique to each tile when a modulated electric current is applied and which is received by the corresponding coil on a neighboring tile), magnetic switch based electro-magnet (i.e. edges of tiles have an electro-magnet that may be modulated and when an electro-magnet on one tile is modulated, the induced field causes the magnetic switch to open and close on the neighboring tile) and camera-based (i.e. tiles have optical “fiducial” markers on each side and a camera based system on each side that can recognize the identity, and perhaps the distance and orientation of, neighboring tiles). To detect absolute position of tiles, a number of different methods may be used, including but not limited to radio received signal-strength (RSS) triangulation, sonic or ultrasonic (i.e. time of flight) based triangulation and surface-location sensing (i.e. the devices themselves sense their position on the surface using a camera while resting on a surface with a unique spatial pattern or some other technique of sensing.

Still referring to FIG. 1, additionally, multiple such individual actions occurring on one or more of the object 10 sensor inputs, executed in parallel, serially, or some combination, can be processed by the tiles and the software (host) as a compound action. In this context a compound action can include initiating an action with a same type of sensor but on two or more manipulable blocks or initiating two or more different sensors on the same manipulable block. Depending on the specific configuration of the software, such single or compound actions can then trigger software subroutines or change the state of the system in the same manner as actions above.

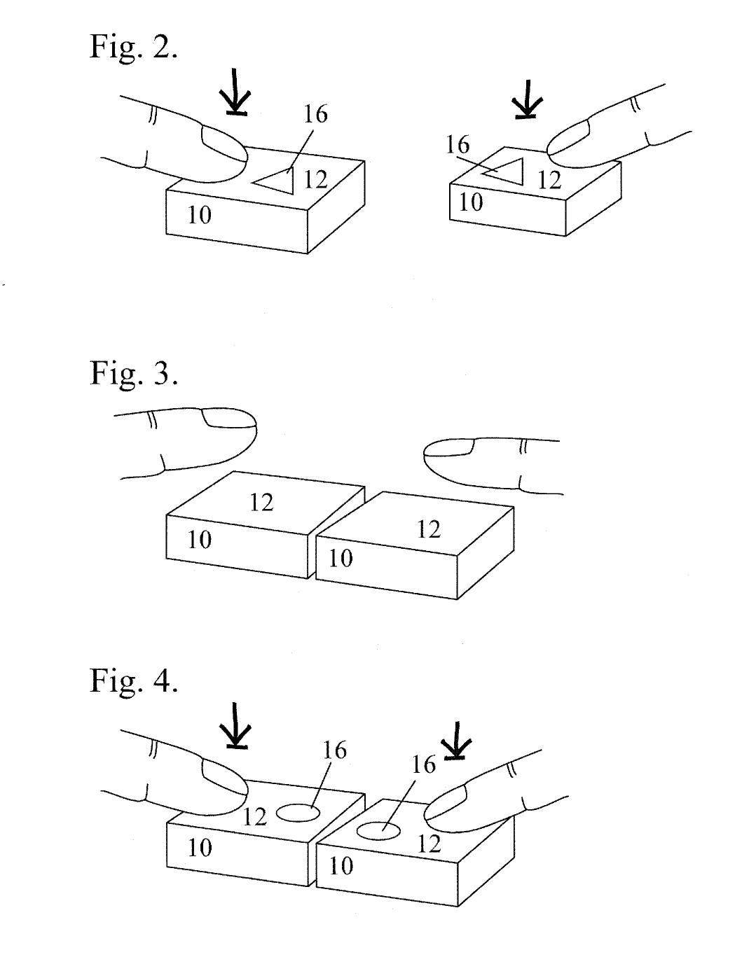

Notably, the software behavior, state, or subroutines triggered by compound actions can be different from the behavior triggered by its component actions. As an example, consider FIGS. 2, 3 and 4, all showing instances of the same example system of objects 10 running the same or comparable software. In FIG. 2 a user is shown depressing push button input sensors 12 or touch actions that are configured in the software to display triangle shapes as a visual indicator on display surface 16. In FIG. 3 the objects 10 have been moved adjacent to one another (arrangement action), but with no result programmed in software. Yet in FIG. 4, with the objects 10 adjacent to one another, when the user depresses the push button sensor input 12, a compound action occurs comprised of both arrangement action and touch actions. For this compound action, as an example, the software is configured to display circular shapes as visual indicators on display surface 16. One potential application of this event is a “checkers”-like interaction. Each object could graphically represent a checker piece. Depressing the push button input sensor on the object 10 could cause the piece to virtually move to an open space on the checkerboard. When the objects 10 are moved adjacent to one another, there is no change in visual feedback. However, when the objects 10 are adjacent to each other and the user depresses the push button sensor, the piece could be graphically “kinged,” whereby one object 10 could display an empty spot and the piece displayed on the other object 10 could virtually become a “king” piece.

Another example could involve virtually moving a character from one object 10 to the other. Graphically depicting a gopher on a trail in a maze is a more specific implementation of this example. Without being adjacent to one another, objects 10 display a map of the maze when the user depresses the push button sensor inputs. When placed adjacent to one another, the displays remain unchanged. Conversely, upon the user placing the objects 10 adjacent to one another and depressing the push button sensor inputs, the gopher could graphically move between objects 10.

According to one embodiment of the present invention software architecture implements correspondence between physical interface elements and software elements. These software elements can take the form of individual software objects that reside in memory on a single system that supports and runs the architecture. In one instance these software elements may be simply a collection of variables and behaviors resident in the computational architecture of the physical interface devices themselves or they may be situated elsewhere, for instance on a remote machine or machines on the internet. Software actions on the software elements can propagate to the physical interface elements, updating their internal state and optionally triggering output that is perceptible to the user. Additionally, actions that the user applies to the physical interface elements may update the internal state of the software elements and trigger further actions as defined by the software behavior such as updating the physical condition of the physical objects.

In one embodiment of the present invention, software objects, for example objects implemented by object-oriented programming languages, can be used to implement the correspondence between physical interface elements and software elements. In an implementation that uses software objects, the execution of software “methods” exposed to the programmer by the object is a means of triggering state change and optionally triggering user-perceptible feedback on the physical interface element. User interaction with the physical interface elements can be reflected back in updates to the internal state of the corresponding software objects and can optionally trigger additional actions as determined by the software behavior. For example, as a result of a specific arrangement of a set of objects 10, the resulting action, as determined by the software, can be to generate a particular sound by one or more of the objects or by a computing system separate from the objects. Alternatively, the specific arrangements of the objects may result in graphical feedback being displayed by one or more of the objects or some message being presented by a computing system separate from the objects.

As an example, the objects 10 may correspond to pieces of a puzzle being solved by the user and specific arrangements of the objects may correspond to valid solutions of the puzzle. A user arranging the objects as a valid solution is informed of that fact by graphical feedback, audio signals, or other kinds of messages. One instance of this could be pieces of a jigsaw puzzle graphically shown on objects 10. When the images displayed on objects 10 are correctly aligned, a “ding” could sound and flash of green color depicted on the objects 10. In another example, a novel music sequencing game includes objects 10 that represent sounds, as indicated by graphical feedback, audio signals, or other kind of messages. The game plays a sequence of sounds through a speaker device either on the objects 10 or on another device, such as a PC or mobile phone. The game requires the user to physically arrange the objects 10 in a sequence that corresponds to the audio sequence and shake them to the correct rhythm. A user arranging the objects as a valid solution is informed of his or her success by graphical feedback, audio signals, or other kinds of messages.

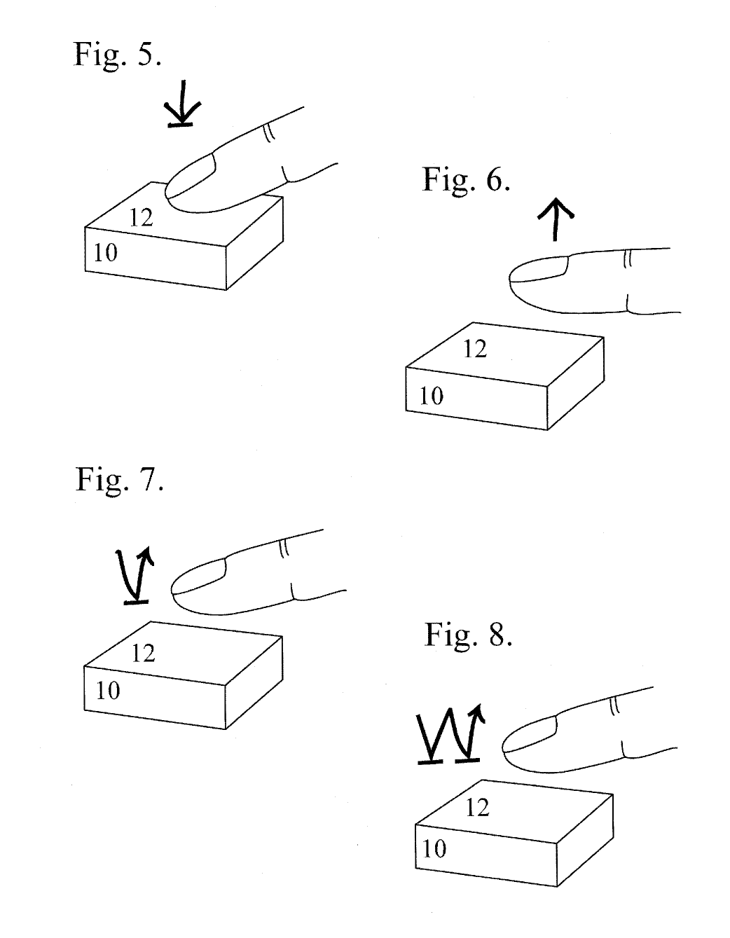

FIGS. 5, 6, 7, and 8 show examples of a physical object 10 equipped with integrated push button input sensor 12. The user can push and release this button sensor 12 in various ways, each resulting in different single object touch action, and wherein each push and release triggers further actions as defined by software behavior according to the specific designs of the software developer. These specific actions and the specific parameters of the action (including but not limited to time, force, speed, or duration) are determined by the programmer. FIG. 5 depicts a user depressing push button sensor input 12 while FIG. 6 shows a user releasing push button sensor input 12.

Included in the description are flowcharts depicting examples of the methodology which may be used to update the state of one or more objects due to physical action induced by a user. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer, or, on another programmable apparatus, to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

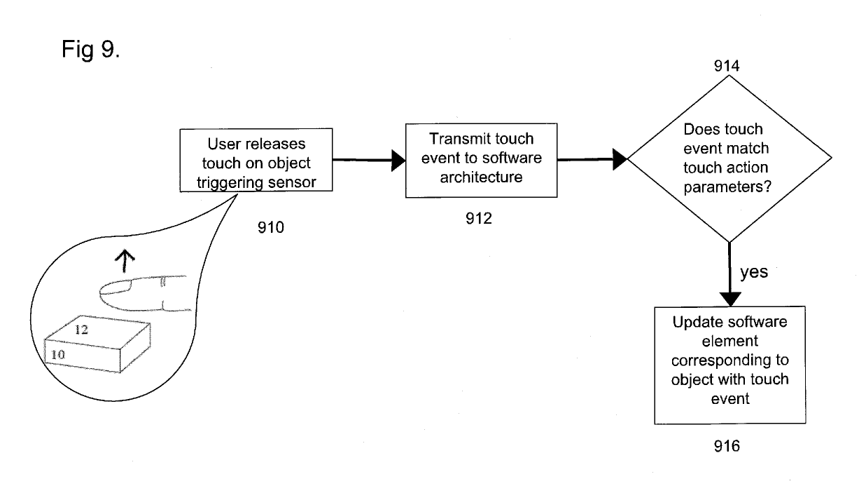

FIGS. 9-11 depict flowcharts by which user interaction with one or more objects is interpreted, analyzed and acted upon. Note that these Figures and flowcharts serve only as examples of how the software architecture operates; similar diagrams apply to all the actions described in this document and to other like actions not described here. As depicted in the process shown in FIG. 9, when the user releases an object 10, 910 an event is transmitted to the software architecture 912. When the release event matches the release action parameters 914 the software updates the object 10 with a release event 916. Should the event not match the action parameter, the examination terminates. One implementation of this diagram according to the present invention would include measurements by a push button sensor input that is wirelessly transmitted to a host computer, on which elements of the software architecture can reside. The architecture residing on the host computer determines whether the release event corresponds to a release action. In one instance of the present invention the release action can comprise verifying that the time between the earlier press event and the release event was of a sufficient duration. At this point, the architecture updates a software element corresponding to the object 10. A software application using the architecture of the present invention could thus be notified of this release event, and change state accordingly. The release event is likely to be used in conjunction with the touch event described above and for the aforementioned answering question the release event ends the answer selection process for a given round. Likewise, in the “Whac-a-mole™” game, the release event allows the user to initiate a subsequent touch event.

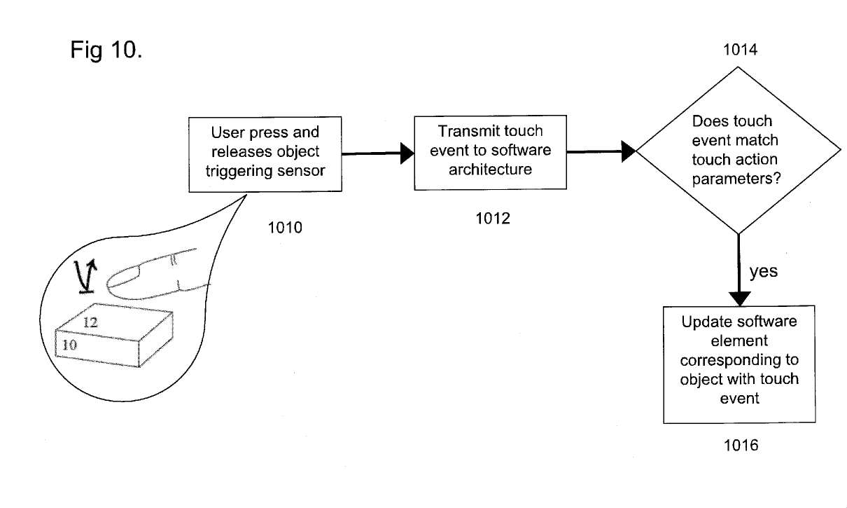

In FIG. 7 a user is shown clicking (rapid press and release) button sensor input 12. Referring now in addition to the flowchart depicted in FIG. 10, when the user clicks 1010 an object 10, an event is transmitted 1010 to the software architecture. When the click event matches 1014 the release action parameters the software updates the object 10 with a click event 1016. A specific implementation of this diagram can include measurements by a button sensor input. This sort of event can be wirelessly transmitted to a host computer on which elements of the software architecture reside. Note that in other versions the software architecture can reside among the manipulable objects and in another version of the present invention the software architecture can be distributed among the manipulable objects and a host computer. The software architecture determines whether the click event corresponds to a click action, by, for example, verifying that the press and release events happened in succession within a short amount of time. At this point the architecture updates a software element corresponding to the object 10 and a software application using the software architecture described herein can thus be notified of this click event to change its state accordingly.

A click event could be used similarly to the touch event, but could also be used in conjunction with the touch and release events to indicate commitment. For example, using the answering question example from above, the touch event could highlight a particular answer, and the click event could confirm that answer selection. Another example could be a game in which an auditory cue is given and the user tries to click the object 10 at the correct moment of tempo.

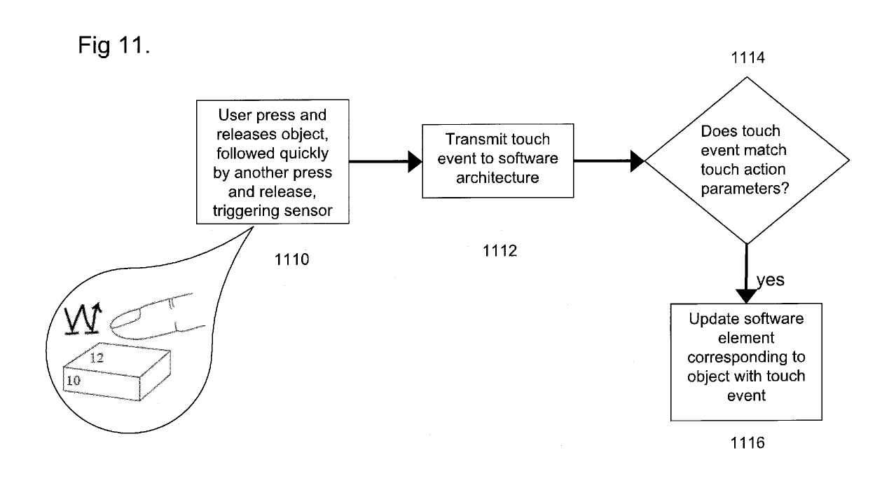

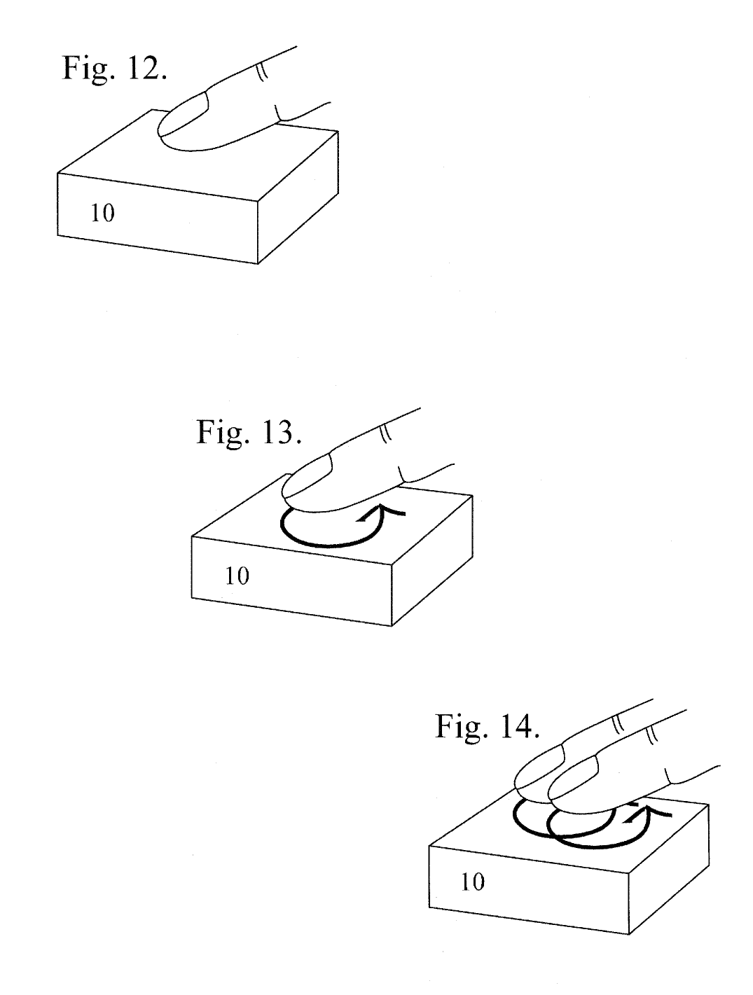

FIG. 8 shows a user double-clicking (rapid press and release, then another press and release) button sensor input 12. The process addressing this sort of user interaction is shown in FIG. 11. As shown, when a user double-clicks 1110 an object 10 an event is transmitted 1110 to the software architecture. When the double-click event matches 1114 release action parameters the software updates 1116 the object 10 with a double-click event. One implementation of the diagram shown in FIG. 11 would include measurements by a button sensor input. This event can be wirelessly transmitted to a host computer and/or other manipulable objects on which elements of the software architecture reside. The architecture determines whether the double-click event corresponds to a double-click action, by, for example, verifying that the press and release events happened twice in succession within a short, predetermined, amount of time. At this point, the architecture can update the software element corresponding to the object 10. A software application using the architecture could thus be notified of this double-click event and change state accordingly. Similar to the click event, the double-click event could be used to confirm an action from the user, such as selection of a highlighted answer choice. A basketball-type game is another example of a double-click event. In order to virtually dribble the basketball, the user could initiate a double-click event.

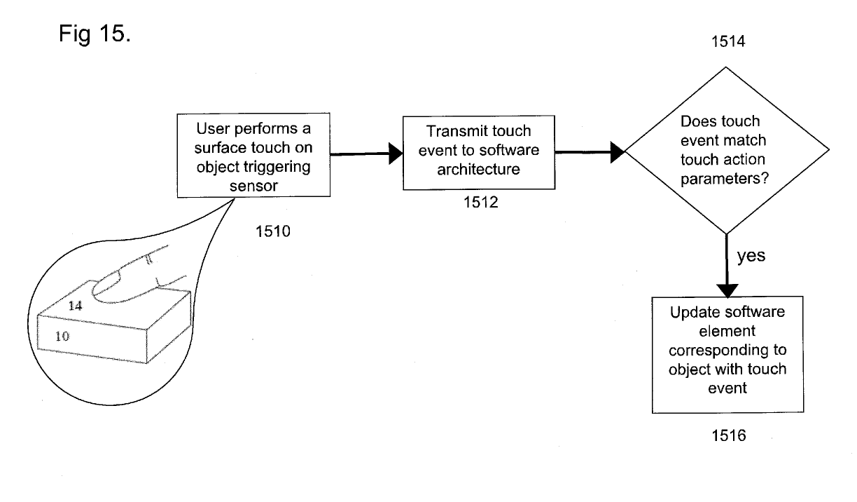

FIGS. 12, 13, and 14 show examples of a physical object 10, equipped with integrated touch surface 14 that allows the user to perform touch actions by touching the object's surface. As shown in FIG. 12, a user performs a touch action by making contact with the surface 14. FIG. 15 shows a process by which the creation of an event 1516 when a user performs a surface-touch 1510 on an object 10. As before, this touch 1510 can be transmitted 1512 to the software architecture. When the touch 1510 matches 1514 the touch action parameters the software updates the object 10 with a touch event 1516. One specific implementation of this type of interaction would include measurements by capacitive touch screen. This event can be wirelessly transmitted to a location on which elements of the software architecture reside. In one instance this location may be a host computer and in other instances it may be to other manipulable objects. The software architecture can then determine whether the touch event corresponds to a touch action, by, for example, verifying that touch event 1516 was of a sufficiently long duration or with sufficient pressure. At this point, the architecture updates a software element corresponding to the object 10.

A software application using the architecture of the present invention could thus be notified of this touch event, and change state accordingly. The examples illustrated above for press events apply equally to touch events. However, the touch events enable the user to select certain areas within one display on the object 10. An example of this includes a pattern recognition game. For example, multiple colored symbols can be graphically depicted within one display on the object 10 and the user can identify like-colored groupings of symbols by initiating a touch event. As a result of this event, the selected grouping is virtually replaced with another set of symbols, indicating the success of the event to the user. FIG. 13 depicts a user performing a touch action by moving his/her finger across the surface 14.

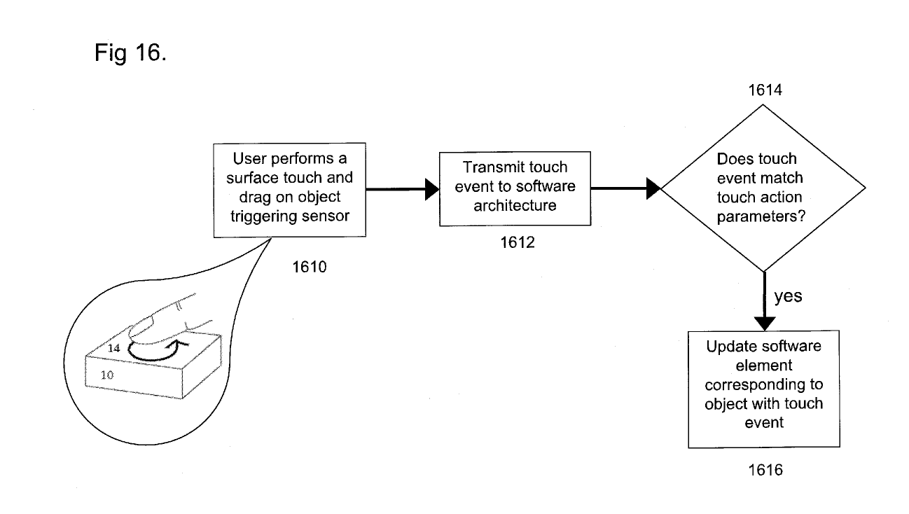

Referring to FIG. 16, when a user performs a surface touch and drag 1610 on an object 10 an event can be transmitted 1612 to the software architecture. When the touch and drag event 1610 matches the touch and drag action parameters 1614 then the software updates the object 10 with a touch and drag event 1616. A specific implementation of this diagram as embodied in the present invention can include measurements by capacitive touch screen. This event is, in one version of the present Mention, wirelessly transmitted to a host computer, on which elements of the software architecture reside. The architecture determines whether the touch and drag event corresponds to a touch and drag action, by, for example, verifying that touch and drag events occurred in succession with a sufficiently long duration. At this point, the architecture updates a software element corresponding to the object 10. A software application using the architecture of the present invention could thus be notified of this touch and drag event, and change state accordingly. An example is graphically moving an item from one portion of a display to another. The touch event selects the object, and the drag event virtually moves the object until the event has ended, at which point the virtual item has changed location within the display. The touch and drag event could also instantiate visual or auditory feedback that would continually change for the duration of the event. An example of such an event includes a drawing application where a virtual line follows the direction and magnitude of the drag event, creating an image virtually drawn by the user's finger. In FIG. 14 the user is performing a touch action by moving multiple fingers across the surface 14.

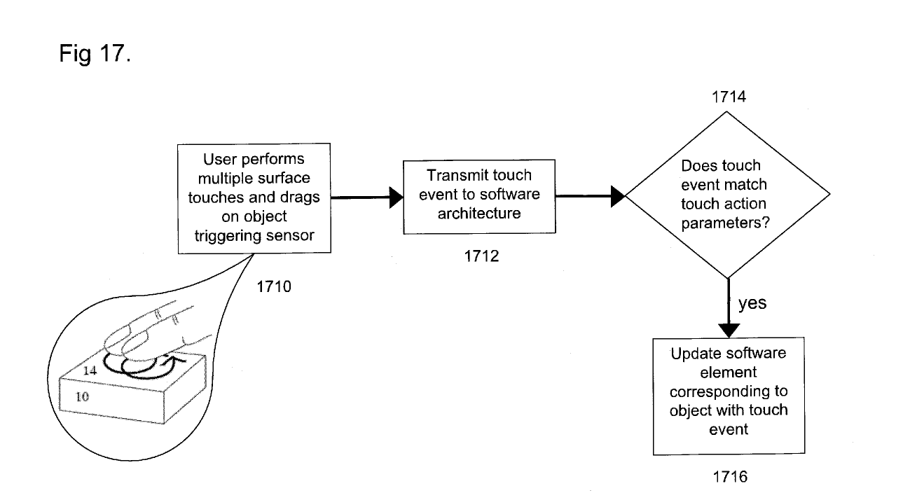

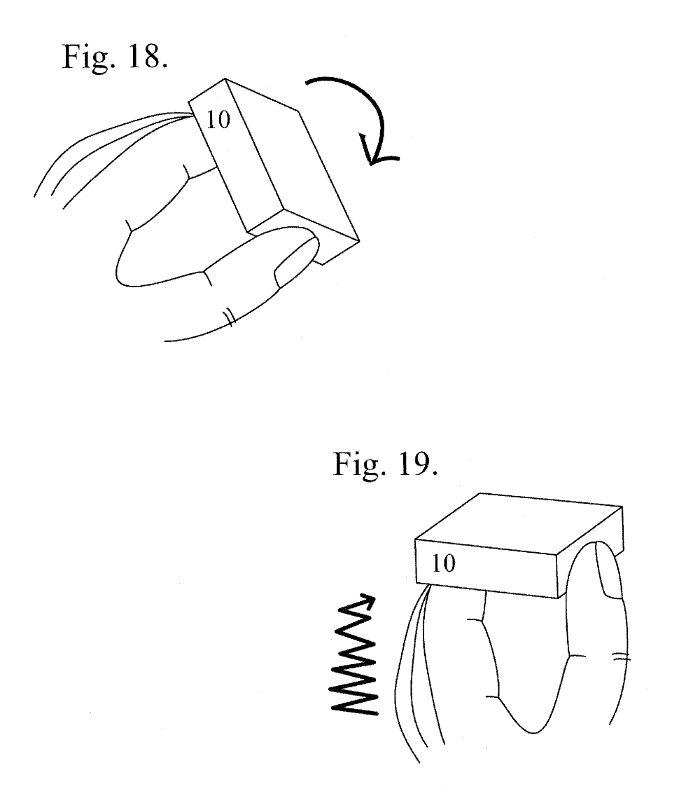

Referring to FIG. 17, when a user performs multiple surface touches and drags 1710 on an object 10, an event occurs that can be transmitted 1712 to the software architecture. When the touch event matches 1714 the touch action parameters the software updates 1716 the object 10 with a touch event. A specific implementation of the process shown in FIG. 17 can include measurements by a capacitive touch screen. Moreover this type of event can be wirelessly transmitted to one or more locations on which elements of the software architecture reside. The software architecture determines whether a touch event corresponds to a touch action by, for example, verifying that multiple surface touch and drag events occurred within a sufficient time frame. When such an occurrence takes place the architecture updates a software element corresponding to the object 10. A software application using the architecture can thus be notified of a touch event and change state accordingly.

Consider the following example: A multiple surface touch and drag event can be used to change the viewable portion of a map. Whereas the touch and drag event can move items within the display, a multiple surface touch and drag event can move the whole display area or reshape the area (expand or reduce). Notably, the gesture response can differ depending upon the direction of drag. For example, in a car-selection portion of a racing game, a top-to-bottom drag might be used to scroll through a list of possible types of cars, while a left-to-right drag could change the color and car accessories.

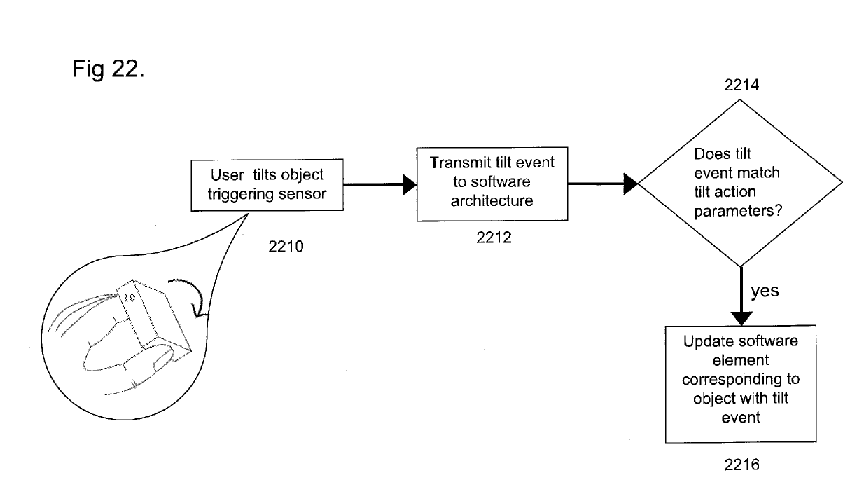

According to another embodiment of the present invention the activity or movement of the object itself can generate an event. FIGS. 18, 19, 20 and 21, show a user performing a motion action on a single object 10. For example, FIG. 18 shows the user tilting an object 10. Referring in addition to FIG. 22, when the user tilts 2210 an object 10 an event is generated and transmitted 2212 to the software architecture. When the tilt event matches 2214 one or more tilt action parameters the software updates 2216 the object 10 with a tilt event. One example of a tilt event, according to an embodiment of the present invention, can include measurements by an internal accelerometer, tilt sensor or other acceleration-sensitive sensor. This event can then be wirelessly transmitted to a location where the software architecture resides. The software architecture determines whether the tilt event corresponds to a tilt action by, for example, verifying that the tilt event was of a sufficiently significant angle relative to a base plane. At this point, the software architecture updates the software element corresponding to the object 10. Accordingly, a software application using the architecture could thus be notified of this tilt event, and change state accordingly. For example, an object displaying a particular color can “pour” the color into another object of another color resulting in the second block varying the hue of the display according to the event. In doing so the “colors” are mixed by the action of tilting the object as is registered by the software architecture.

Notably, the software can respond differently depending on the magnitude of tilt. For example, a ball displayed graphically on the screen could be animated to roll towards the side of the object 10 that is tilted down. It could roll faster or slower depending on the magnitude of the tilt or to varying sides of the object if the tilt involved changers in two different planes of motion simultaneously. The tilt mechanism can also be used to scroll through a menu of items. Keeping the object 10 tilted in one direction would scroll through options that would appear in succession on the screen. The tilt event can be ended by the user returning the object 10 to a flat orientation and the option that is on the screen at the time the tilt event terminates would remain to potentially be selected. Greater angles of tilt could result in faster scrolling.

Another example of how this tilt action can be used as a control device, according to one embodiment of the present invention, is that tilting one object 10 can cause a graphical symbol on another object to change. If a car is depicted driving in a lane of a road on another object, a first object 10 could be tilted to change the lane in which the car is driving. Thus the motion or tilt of a first object can alter the state of a second object. Another type of motion interaction contemplated by the present invention is shaking.

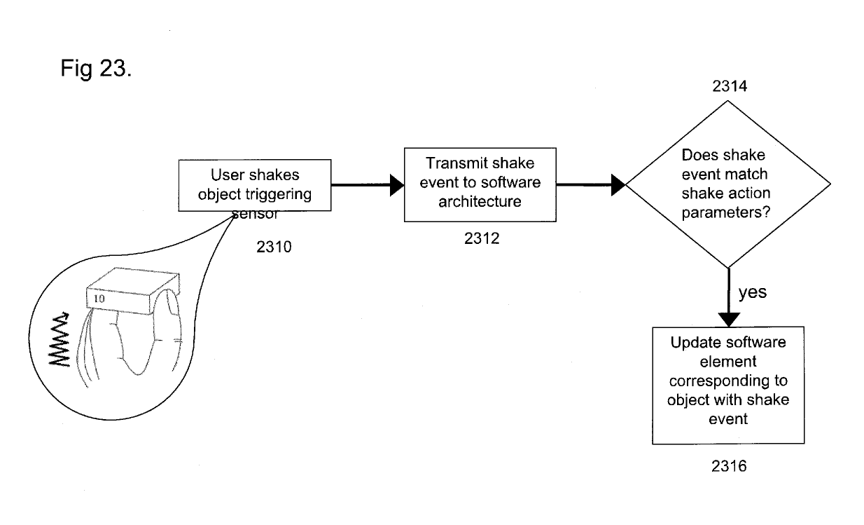

FIG. 19 shows a user shaking an object 10. The shaking motion is measured, in this embodiment, by internal accelerometers. FIG. 23 is an example of the software architecture used for a shake event. As depicted, a user shakes 2310 an object 10 resulting in an event being transmitted 2312 to the software architecture. When the shake event matches 2314 parameters defining a shake action the software updates 2316 the object 10 with a shake event. The software architecture determines whether a shake event corresponds to a shake action by, for example, verifying that the accelerometers registered random reversals in direction occurring over a sufficient time period to warrant the existence of what would be deemed shaking. At this point, the architecture updates a software element corresponding to the object 10 indicating the event. A software application using the architecture could thus be notified of this shake event and change state accordingly. A shake event can serve a variety of functions for user interaction. For example, it may advance an application to a new state that is represented graphically by a menu item shown on the display of the object 10. This change in the display or new state can result in state updates to other objects including causing the original object 10 to display a graphic providing visual feedback to the user that the system recognized the shake event.

One example implementation of a shake event could be an event that initiates the start of a new round of a card game. The shaking event could “shuffle” the cards displayed graphically on the objects 10 thereby allowing a new round of the game to begin. A different application of a shake event can be to change the internal state of the virtual world displayed on a plurality of objects 10. In this instance the shaking event can cause the figures graphically displayed on each object to have their locations changed within the same display or across displays. Yet another example utilizing a shake event as a control input is as a method of scanning through options. When inside a menu of options, each item could be presented singularly on an object 10. Each shake event can cause the presented option to cycle through all of the potential options.

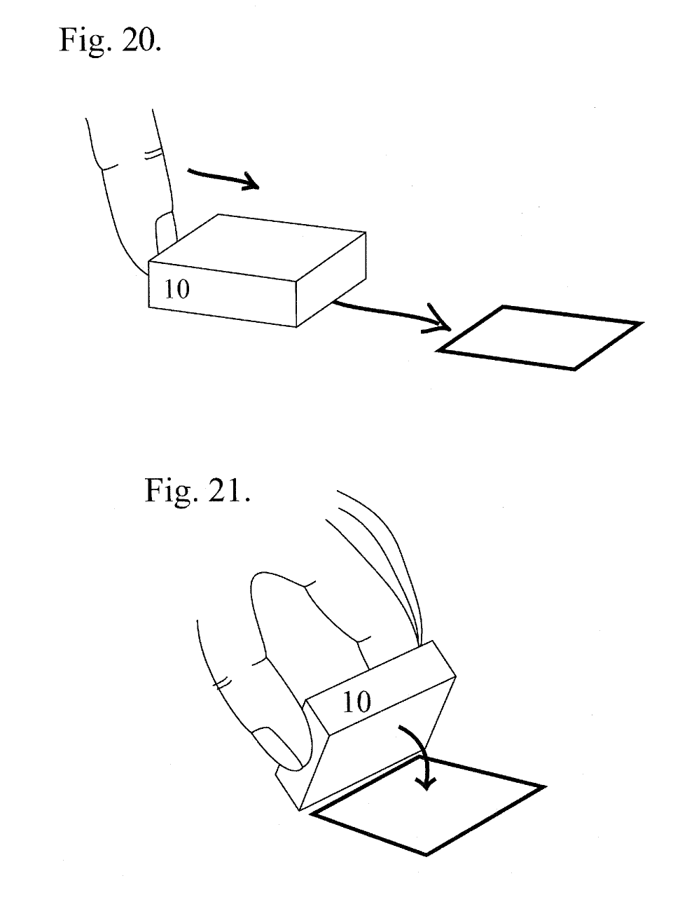

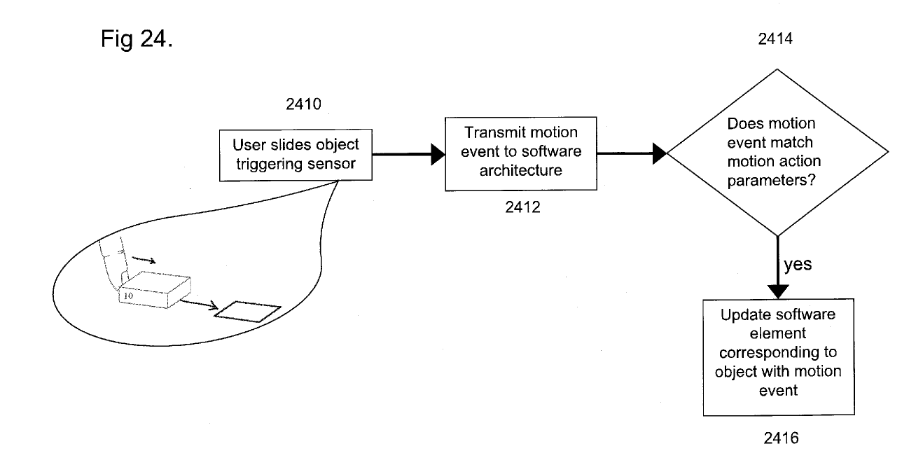

Another aspect of the present invention, depicted in FIG. 20, is the recognition that the object 10 is in motion as measured by an accelerometer, gyroscope, or other sensor/system. Referring in addition to FIG. 24, when user moves 2410 an object 10, this event can be conveyed 2412 to the software architecture. When the user slides 2410 an object 10 the resulting event is transmitted 2412, according to one embodiment of the present invention, to the software architecture resident on a host. When the motion event, the registered sliding of the object, matches 2414 one or more motion action parameters the software updates 2416 the object 10 with a motion event. According to one embodiment, measurements by an internal accelerometer, gyroscope, or other sensor/system can trigger an event that can be evaluated to determine whether it should be classified as an action. The architecture resident on a host computer determines whether the motion event corresponds to a motion action by, for example, verifying that the motion event has a sufficient velocity. That is, whether the object 10 was moved over a sufficient distance within a given time period. At this point, the architecture updates a software element corresponding to the object 10.

A software application using the architecture can thus be notified of a motion event and change state accordingly. For example, an object that is placed into motion can advance an application to a new state that is represented graphically by a menu item shown on the display of the object 10. This change of state can further result in state updates to other objects in the local vicinity including causing the original object 10 to display a graphic providing visual feedback to the user that the system recognized the motion event. For example, consider a car depicted graphically on the object 10. A motion event could cause an animation that would show the wheels on the car turning in the direction of motion. Another example could be a realistic physics simulation to depict the principle of inertia. With a ball graphic shown on the object 10, a motion event could trigger the balls movement on the object and subsequent motion events could mimic potential physical reactions of the ball. For example, collisions of the objects in motion can be combined with the direction or orientation of the objects to depict a resulting vector.

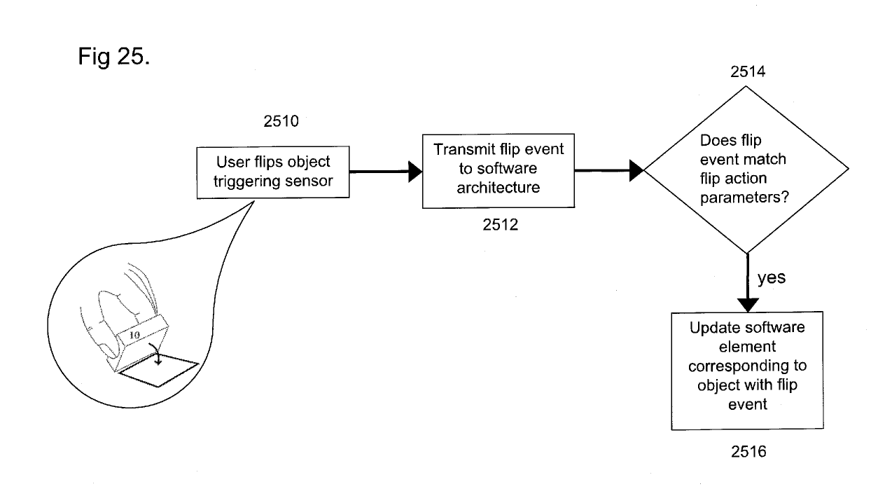

Another physical action interpreted by the present invention, shown in FIG. 21, is a user flipping an object 10 over as measured by an accelerometer, gyroscope or other sensor/system. FIG. 25 describes a process by which a user flips 2510 an object 10 over creating an event that can be transmitted 2516 to the software architecture. The flipping of an object 10 results in an event being transmitted 2512 to the software architecture. When the flip event matches 2514 predefined flip action parameters the software updates 2516 the object 10 with a flip event. As with other motion events the software architecture determines whether the flip event corresponds to a flip action. In this case, for example, the action may comprise verifying that the flip event was of sufficient angle to distinguish it from a tilt event thus enabling an appropriate change of state. For example, multiple flipping events may switch the application back and forth between states that were represented graphically on the display of the object 10. Using this mechanism, a memory game that requires users to retain the details of a specific graphical image could be implemented to test short-term memory retention. Another example is using the flipping event to indicate the object 10 to display a previous state in order to “restart” or “undo” an action.

The construct of groups is a part of the described software architecture of the present invention. Some embodiments of the present invention can lack the construct of groups; however groups can provide certain utility and conveniences to an application developer. In one embodiment, a group is considered to be a specific subset of the available physical interface elements. Membership in the group can be determined by an instantaneous physical configuration of the interface objects (for example, all objects that are currently upside-down or that are currently in motion are part of the group), or group membership may be determined by the architecture independent of the instantaneous state of the objects, or some combination of these. According to another embodiment of the present invention there can be a data structure that specifies the set of interface objects currently belonging to a particular group. Alternately, the members of a group can be determined as-needed only when required by the architecture, but not stored in a persistent manner. The data that specifies the members of a group can reside in memory on a single system that runs the architecture or reside in physical or virtual state in the physical interface devices themselves. The data can also be situated elsewhere, for instance distributed across machines on the internet. Extensions to the construct of an unordered group may include ordering (as in an ordered sequence) or topology (for example, two-dimensional or three-dimensional relationships between elements).

By utilizing a group construct the architecture can operate on a group in a manner that is similar or identical to operations on an individual object. For example, the programmer can invoke selected.displayOn( ) (where selected is the name of a group) as well as obj.displayOn( ) (where obj is the name of a single object) to turn on the display on a group of interface objects, or on a single interface object, respectively. This equivalence between the manner of addressing individual objects and the manner of addressing groups of objects enables the development of sophisticated behavior for a distributed user interface.

Another aspect of the present invention by which user interaction can establish groups includes arrangement actions. For instance, a set of physical interface elements (objects) that are placed near each other on a surface at some predetermined distance from each other can be assigned to a single common group. Similarly, elements placed atop each other can be assigned to the same group. In either of the aforementioned cases, an element (object) that is moved away from the other(s) may be removed from the group.

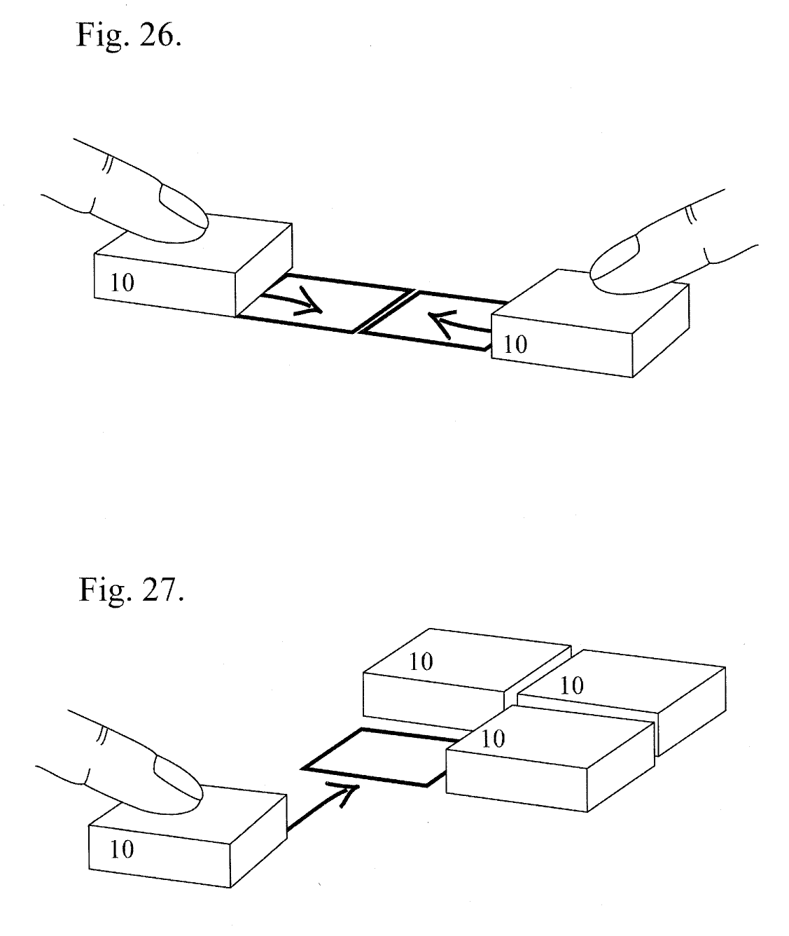

FIGS. 26-33 depict a user arranging one or more objects 10 within a set of objects in order to modify the overall physical arrangement of the group. Note that the detection of such arrangement actions within a distributed tangible user interface may be implemented in a variety of methods, such including but not limited to infrared proximity sensors, induction sensors, or conductive contact mechanisms, or by absolute position sensing techniques such as RF received signal strength triangulation or camera-based computer vision tracking. In FIG. 26 the user performs an arrangement action by moving two objects 10 such that they are determined to be adjacent to one another using one or more internally integrated proximity or adjacency sensors.

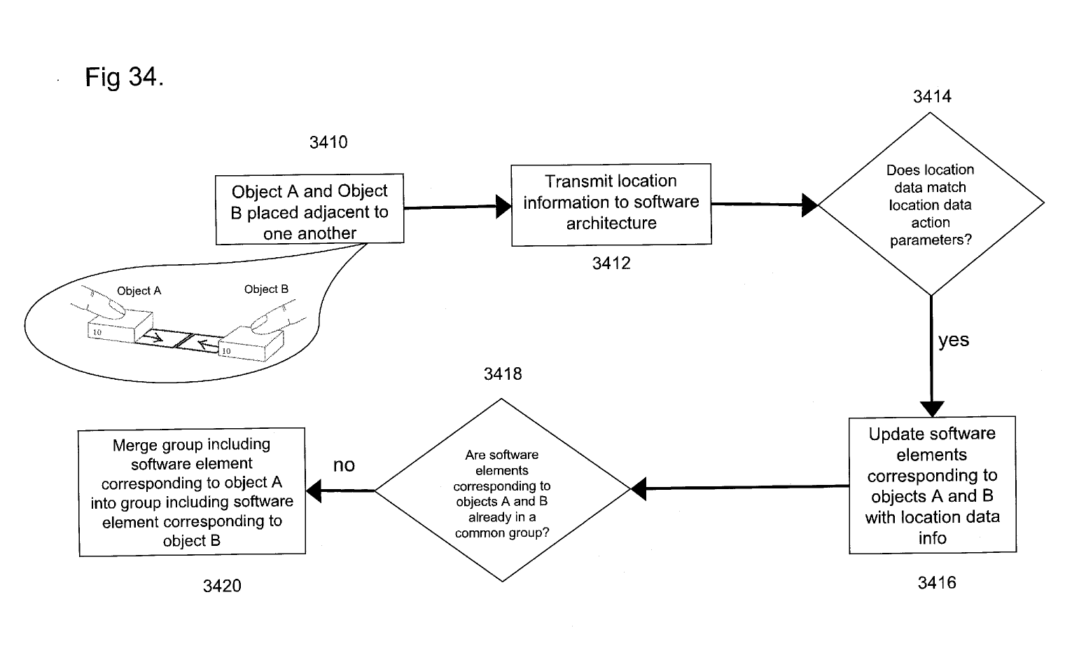

Referring in addition to FIG. 34 a user places 3410 an object A (10) and object B (10) adjacent to one another. Location data is transmitted 3412 to the software architecture and the architecture determines whether the location data meets 3414 required parameters. When the parameters are met the architecture updates 3416 the software elements corresponding to objects A and B. A specific implementation of the process shown in FIG. 34 can include measurements by internally integrated proximity or adjacency sensors. This location information is wirelessly transmitted to a processor on which one or more elements of the software architecture reside. The architecture thereafter determines whether the location data corresponds to a location data action by, for example, verifying that the program allows the state wherein the items represented by object A and object B are adjacent. At this point, the architecture updates software elements corresponding to objects A and B. When the objects A and B are not already in a common group, the software elements corresponding to each object are merged into a group.

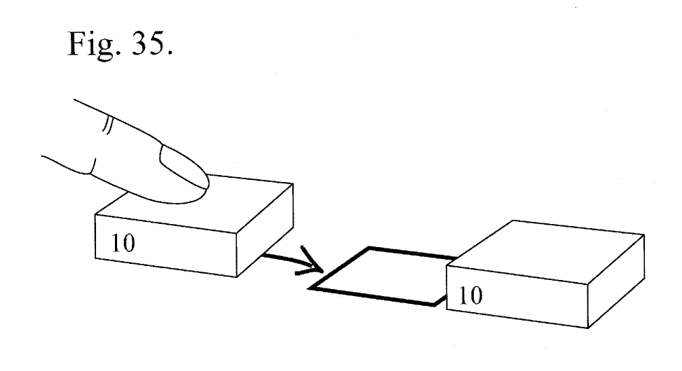

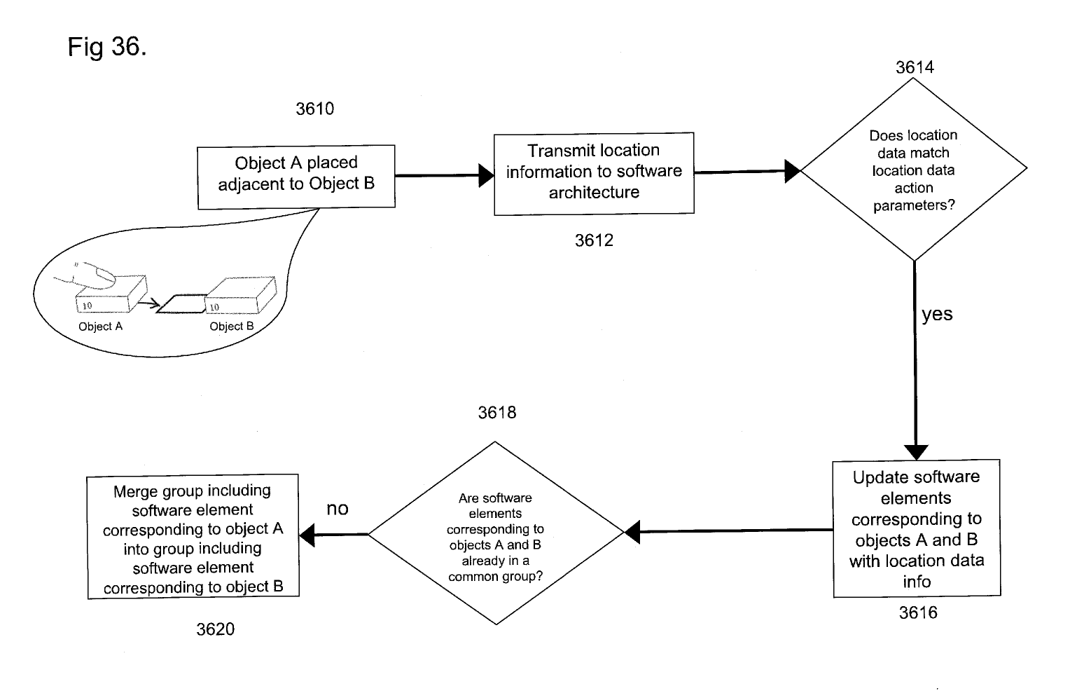

A software application using the architecture described above can thus be notified of the location data and change state accordingly. For example, whereas the objects 10 previously displayed different images, when placed adjacent to one another the images on objects 10 can become the same. The location data can also be used to increase the size of the virtual space. For example, when a ball is graphically depicted bouncing around the virtual area afforded by the display of object A, placing object B adjacent to object A can increase the virtual space such that the ball can be shown bouncing “through” the physical confines of the objects 10. The software response to the adjacency event can differ depending on the location of adjacency. For example, a simple interaction between an object A with a hat displayed on it and object B with a virtual character could have different adjacency events. Placing object A vertically adjacent to object B could cause the virtual character to wear the hat, while placing them horizontally adjacent could cause the virtual character to hold the hat. In FIG. 35, the user performs a similar arrangement action, but by moving only one object 10 to be adjacent to another, stationary object 10, as measured by internal proximity or adjacency sensor. The system architecture, FIG. 36, works similarly as described for FIG. 34.

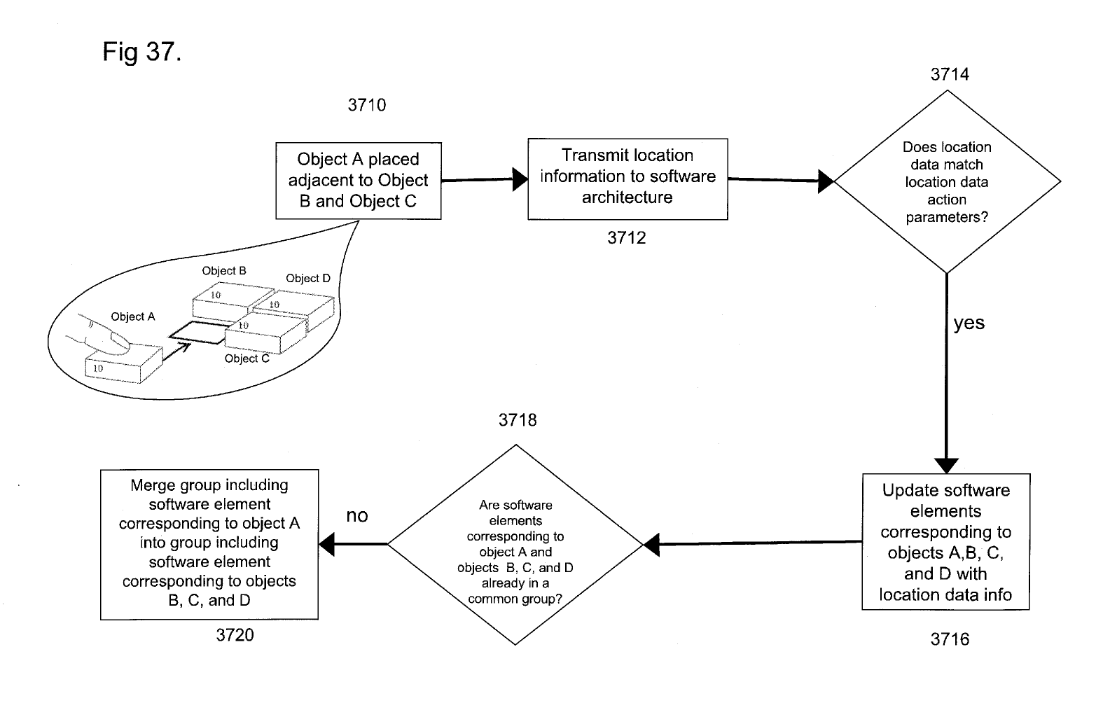

For example, the location data can be used to indicate an action. A personal pet game can be designed having a feeding option displayed on object A and a graphical representation of the pet on object B. When placed adjacent to one another, the pet is virtually fed. In FIG. 27 the user moves one object 10 to be adjacent to an already proximate group of objects 10, expanding the size of the group. Such an expansion of a group is depicted in FIG. 37. As shown a user introduces 3710 an object A (10) to a group consisting of objects B (10), C (10), and D (10). Location data is transmitted 3712 to the software architecture and upon receipt the architecture determines 3714 whether the location data meets required parameters. When the data meets the required parameters the architecture updates 3716 the software elements corresponding to objects A, B, C, and D.

One implementation of this diagram can include measurements by internally integrated proximity or adjacency sensors, similar to FIG. 34. This location information is wirelessly transmitted to a host computer, on which in one embodiment of the present invention elements of the software architecture can reside. The architecture determines whether the location data corresponds to a location data action by, for example, verifying that the distance between object A and objects B and C is sufficiently short. At this point, the architecture updates software elements corresponding to objects A, B, C, and D, when the object A is not already in a common group with objects B, C, and D, the software elements corresponding to each object are merged 3720 into a single group. A software application using the architecture of the present invention can thus be notified of the location data, and change state accordingly. Further, the architecture will update 3718 the status of all groups of objects in the system. For example, the new grouping can advance the application to a new state that is represented graphically on the display of the objects A, B, C, and D providing visual feedback to the user that the system recognized the location data action. More specifically, when an open loop is graphically depicted across objects B, C, and D, the addition of object A to the group could close the loop, which could be represented by graphical and/or auditory feedback on all objects 10.

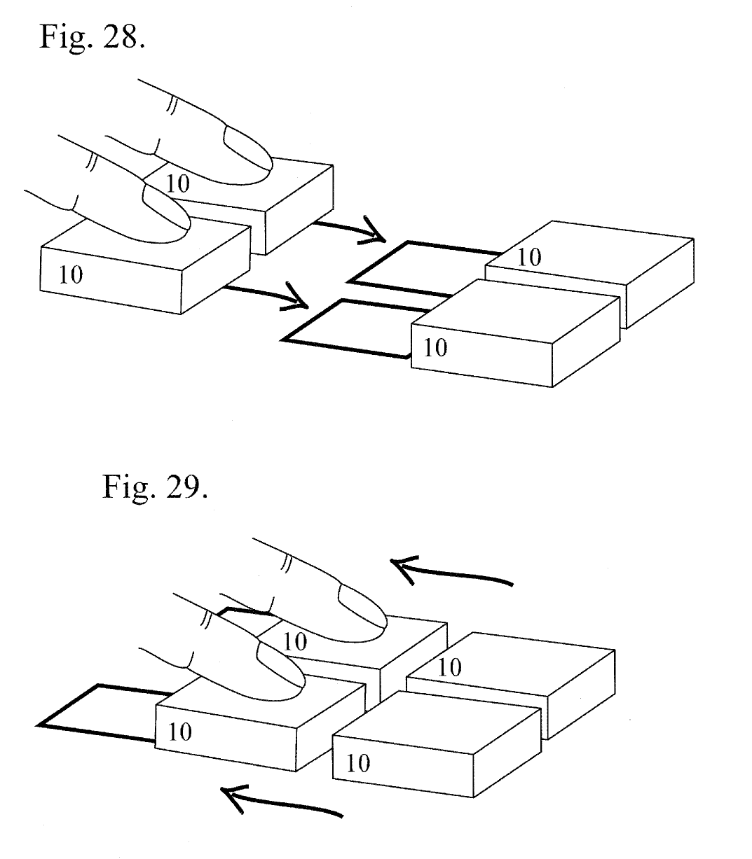

According to another embodiment of the present invention different sections of a maze are displayed on a plurality of objects such as objects B, C, and D. Placing object A adjacent to objects B and C reveals another section of the maze now shown on object A. In FIG. 28 the user moves a group of objects 10 to be adjacent to another group of objects 10, joining the two groups into one.

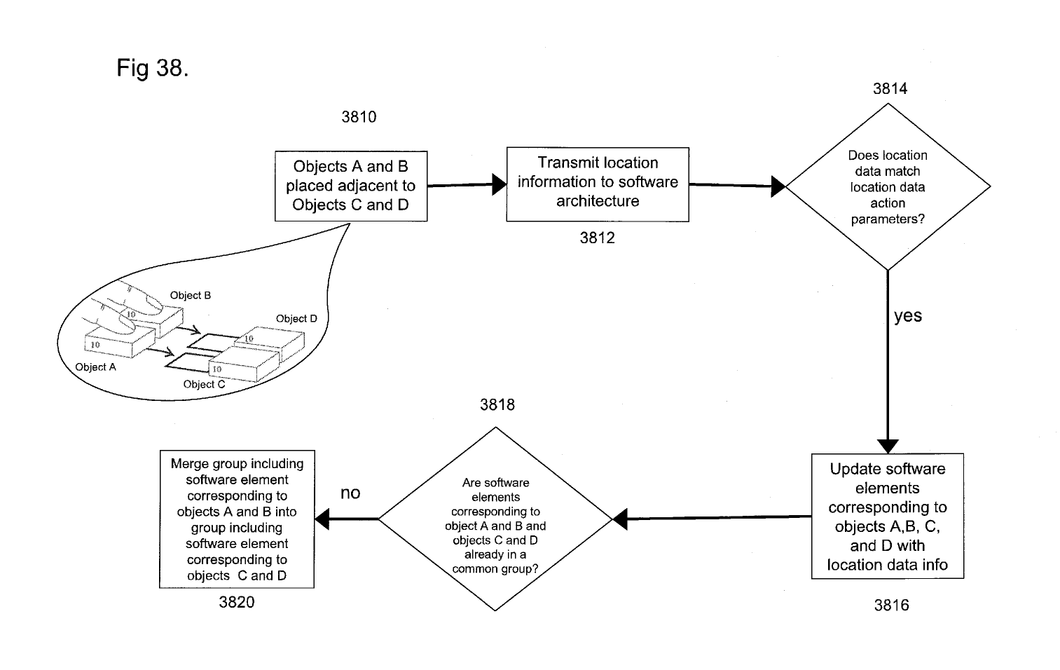

FIG. 38 shows a process by which a group of objects is introduced to and combined with another group of objects. As described in FIG. 38 a user introduces 3810 a group consisting of objects A (10) and B (10) to a group consisting of objects C (10) and D (10). Location data is transmitted 3812 to the software architecture which thereafter determines 3814 whether the location data meets required parameters. When the parameters are met the architecture updates 3816 the software elements corresponding to objects A, B, C, and D. The specific parameters can include measurements by internally integrated proximity or adjacency sensors. This location information is wirelessly transmitted to a host computer wherein elements of the software architecture reside. The architecture determines whether the location data corresponds to a location data action by, for example, verifying that the distance between objects A and B and objects C and D is sufficiently short or within a predetermined distance. At this point, the architecture updates software elements corresponding to objects A, B, C, and D. When the objects A and B are not already in a common group with objects C and D, the software elements corresponding to each object are merged into a single group.

A software application using the architecture of the present invention can thus be notified of the location data, and change state accordingly. For example, a software application may advance to a new state that is represented graphically on the display of the objects A, B, C, and D providing visual feedback to the user that the system recognized the location data action. Consider a jigsaw puzzle. Two correctly matched puzzle pieces graphically depicted on objects A and B could be moved adjacent to two other correctly matched puzzle pieces C and D in order to see if the four pieces all match together. Graphical and auditory feedback could indicate when there was correct placement. In another example, this type of location data action could be useful for organizing photographs or other types of data displayed on objects A, B, C, and D.

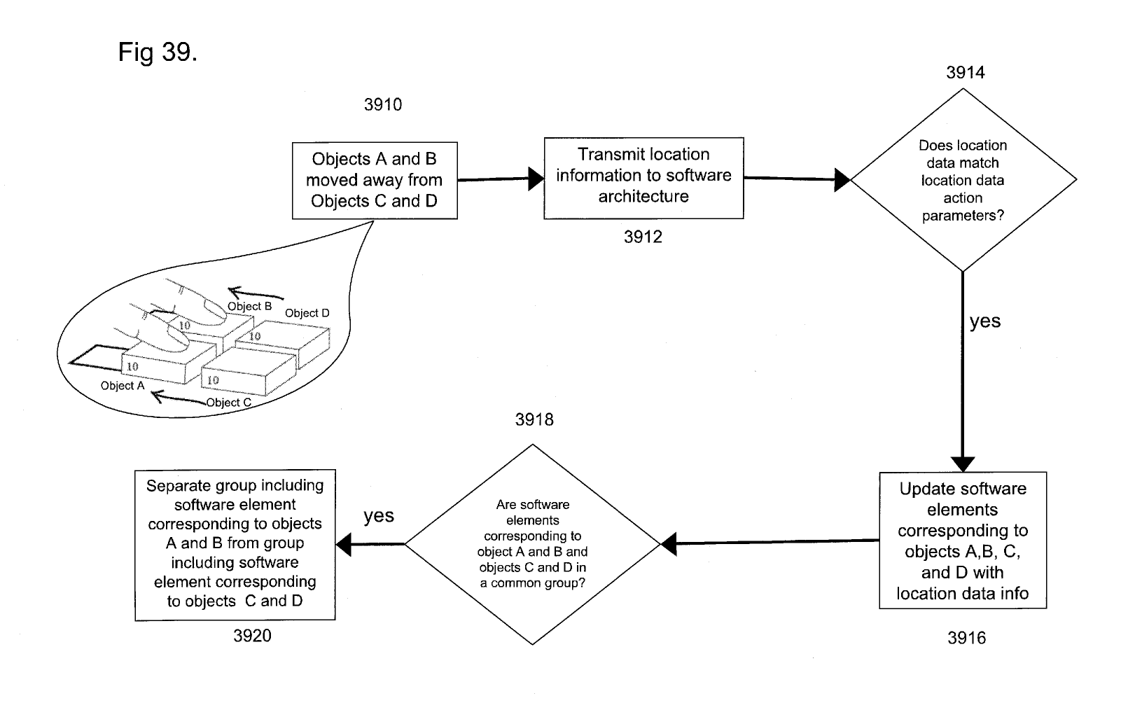

Organizing data such as photographs into coherent collections can be accomplished by moving multiple objects simultaneously so as to be adjacent to stationary objects that were previously grouped. FIG. 29 shows a user moving a portion of a group of objects 10 away from the formed group, thus separating the original group into two separate groups. FIG. 39 shows one embodiment of a process for separating a group comprised of multiple objects into new discrete groups. Initially a user, in this example, moves 3910 objects A (10) and B (10) away from the group including objects C (10), and D (10). Location data is transmitted 3912 to the software architecture resident on a host computer and that architecture determines 3914 whether the location data regarding the move meets required parameters. When the required prerequisites have been achieved the architecture updates 3916 the software elements corresponding to objects A, B, C, and D. This process would likely include measurements by internally integrated proximity or adjacency sensors which would transmit data that can be used to verify that the increased distance between objects A and B and objects C and D is sufficiently large to warrant a group reclassification 3920.

The reclassification begins when the objects A and B are still in a common group with objects C and D. First the software elements corresponding to each object are separated. A software application using the architecture described above is notified of the change in location data and changes the state of the objects accordingly. For example, images that are graphically displayed across all objects 10 could change once a subset of those objects is removed, thereby providing the user with feedback that the location data action occurred. Additionally, the same examples used in FIG. 38 can be applied to FIG. 39. For the jigsaw puzzle, upon getting feedback that the puzzle piece placement is incorrect, the user could move the two sets of objects 10 away from each other in order to attempt another configuration.

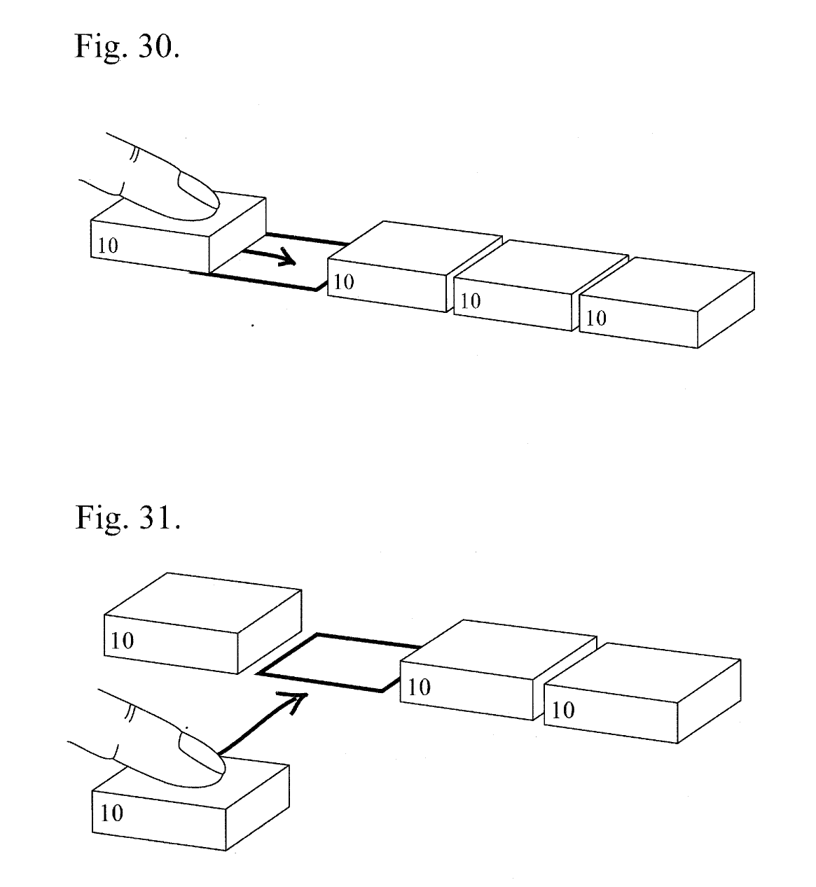

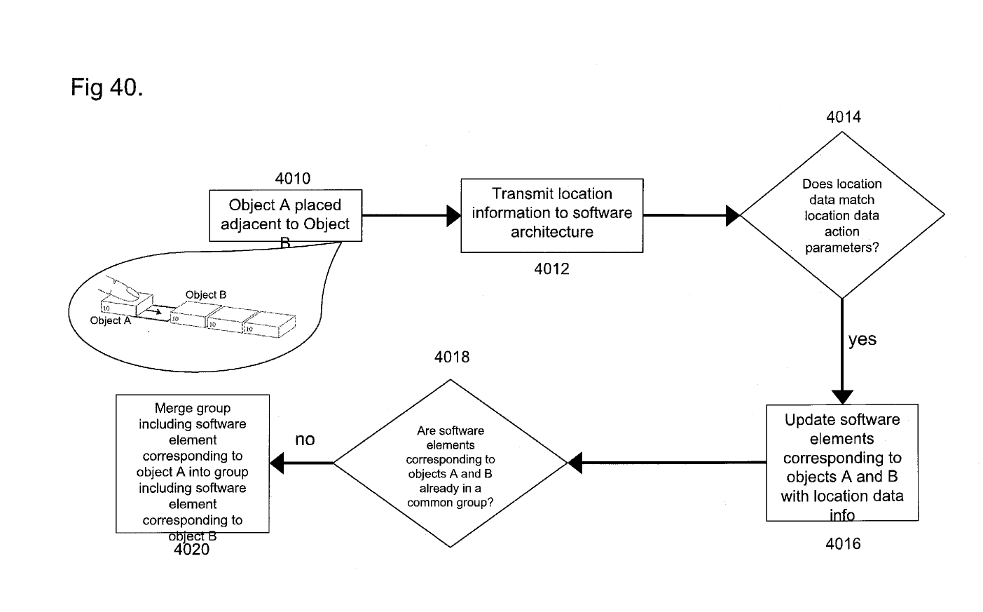

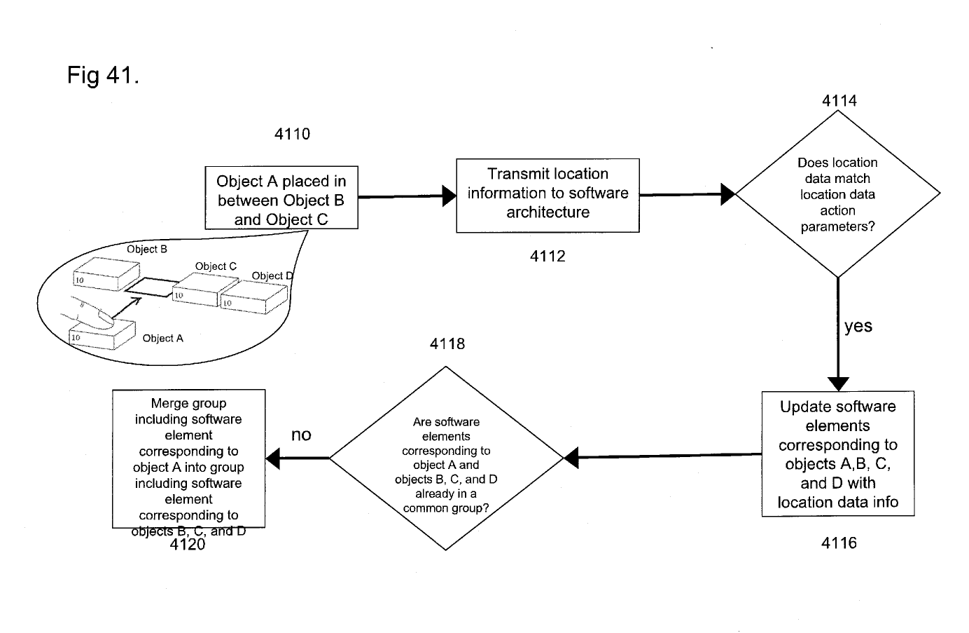

The photograph organizing concept works similarly, as grouping pictures can be a multiple-step process that could require several iterations of removal and addition. Referring again to FIG. 30, the user moves an object 10 to an end of a linear sequence of other objects 10, creating a sequence arrangement. FIGS. 40 and 41 are flowcharts describing a process by which to form a sequence arrangement. In the case of the movement shown in FIG. 30, a user event fauns a group. Note that this is just one example of how the architecture handles the formation of groups. Dissolution of groups could be handled by a similar mechanism. Referring to the process shown in FIG. 40, a user places an object A (10) next to object B (10) 4010. Location data is transmitted 4012 to the software architecture that then determines 4014 whether the location data meets required parameters. When the parameters are met the architecture updates 4016 the software elements corresponding to objects A and B. The architecture thereafter updates 4018, 4020 the status of all groups of objects in the system.

One example of this type of interaction is a train that is progressing on tracks, with each object 10 graphically representing a section of the train tracks. The introduction of object A allows the train to virtually move further along on the tracks, whereby empty tracks would replace the train image on object B and the train image would subsequently appear on object A. Another example is a word spelling game where each object has a different letter displayed on it. The addition of the letter presented on object A could create a word that was previously incomplete.

As shown in FIG. 31 the user inserts an object 10 between other objects 10 to modify a sequence arrangement. The flowchart of FIG. 41 correspondingly discloses a process by which a sequence event occurs when an object is inserted between other objects. Specifically user places an object A (10) in between 4110 object B (10) and object C (10). Location data is transmitted 4112 to the software architecture which then determines 4114 whether the location data meets required parameters for declaring that a sequence arrangement has occurred. When the parameters have been met the architecture updates 4116 the software elements corresponding to objects A, B and C. Moreover, the architecture will update the status of all groups of objects in the system 4118, 4120.

In the present example the architecture determines whether the location data corresponds to a location data action by, for example, verifying that the distance between objects A and B and between objects A and C is sufficiently short. At this point, the architecture updates software elements corresponding to objects A, B, C, and D. When the architecture determines that the objects A and B are not in a common group with objects C and D, the software elements corresponding to each object are merged into a group. For example, object B could have a graphical image displayed that separates it from objects C and D. Upon the introduction of object A, the images shown on objects B, C, and D change to provide feedback to the user of the location data action.

Using the gopher on a trail example described previously, the placement of object A could create a link between the image of a trail displayed on object B and the images of a trail displayed on objects C and D. Without object A, the software would prevent the gopher from being able to graphically transfer from one portion of the trail on object B to another portion of the trail on objects C and D. The introduction of object A also reveals another section of the trail to which the gopher can virtually travel.

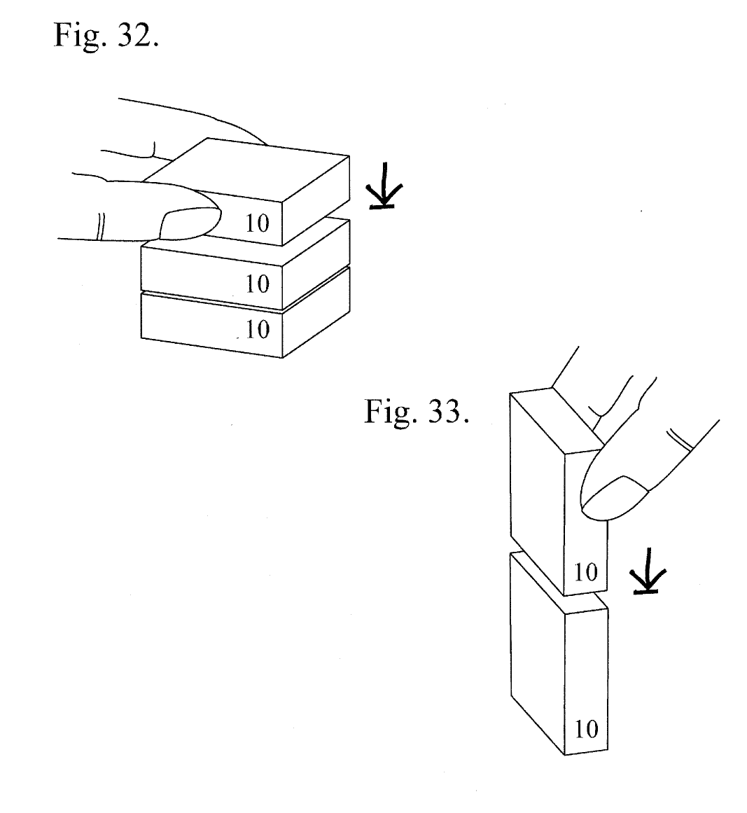

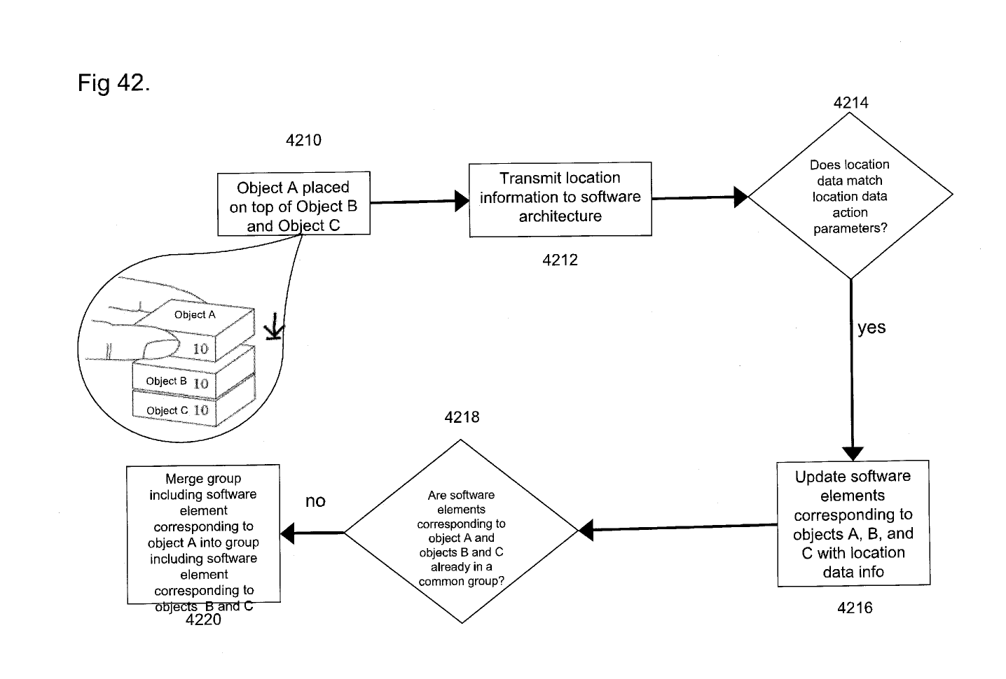

The gestures of the present invention can also be applied to musical arrangements. If each object were to visually represent a different musical note, the insertion of object A between object B and objects C and D can create a musical sequence. Auditory feedback could confirm the correct, or incorrect, placement of the objects 10. FIG. 32 shows a user placing an object 10 on a stack of other objects 10, resulting in a modified stack arrangement. FIG. 42 is a flowchart of a process by which to vertically group a plurality of objects. Such a grouping begins with a user placing 4210 an object A (10) on top of object B (10) and object C (10). Location data regarding the vertical placement is transmitted 4212 to the software architecture which uses this data to determine 4214 whether the location data meets required parameters to establish a new grouping. When the parameters have been met the architecture updates 4216 the software elements corresponding to objects A, B and C. Further, the architecture will update 4218 the status of all groups of objects in the system and merge 4220 the separate objects into a group

To better illustrate this approach of the present invention consider an implementation comprising an image of a building displayed on the top-most object 10. The building could graphically appear taller as more objects were placed on top of one another. Placing a different object on top with the image of a person on it can, for instance, result in the person virtually entering the building, as depicted graphically on the top-most block. Thus the building group interacts with the object representing the person.

Another example could be an addition mechanic, whereby the top-most block can display the quantity of blocks in a given stack. While seemingly trivial, this could be used to teach children how to count and could also teach multiplication when combined with adjacency events. For example, in FIG. 33 the user places an object 10 vertically on the side of another object 10, resulting in a vertical stack arrangement. As with the process described in FIG. 42 the location data transmitted to the host can determine whether the positioning of the object meets predetermined criteria resulting in the declaration that an event has occurred worthy of a state change. Once the event is declared the states of the blocks are updated. For example, object B could have a graphical image displayed on it that is virtually extended onto object A once the location data action occurs.

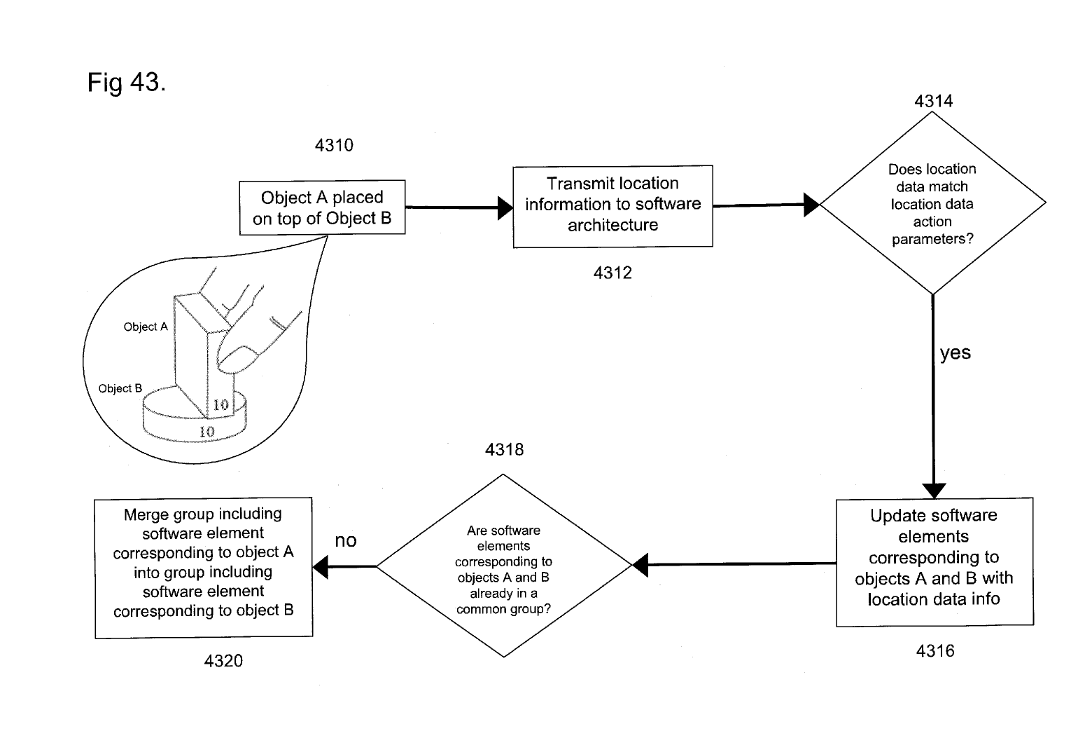

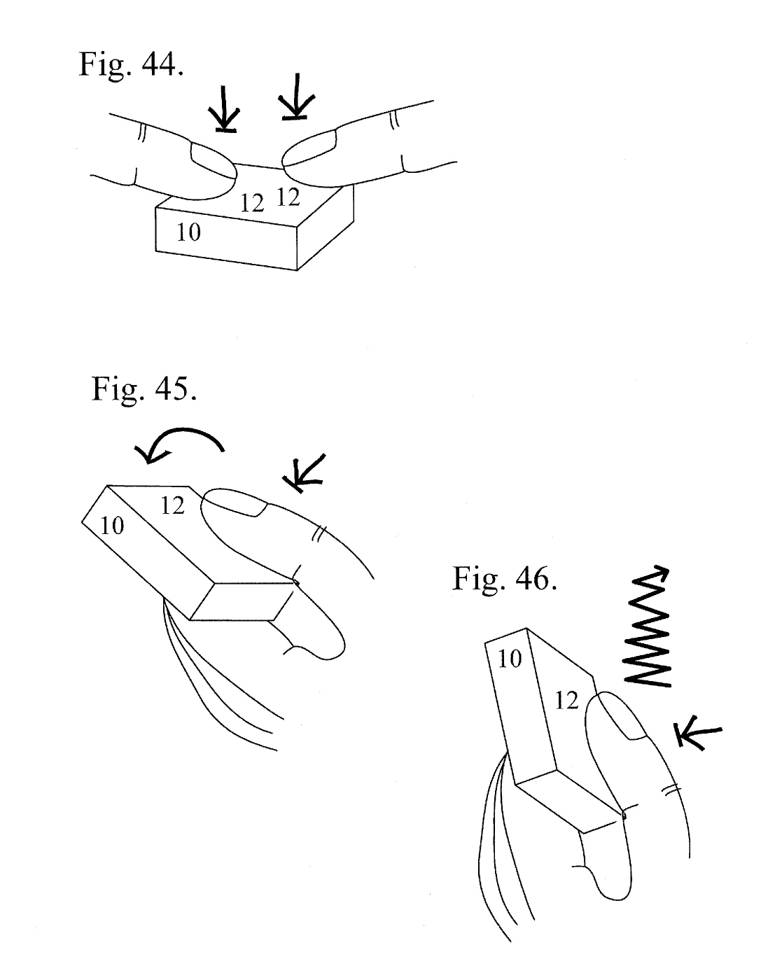

Another example is using the objects to display Chinese characters where text is read vertically. Furthermore, this action could also be used to transfer the image displayed on one block to the image on another, essentially “dropping” a graphical image down. For this example, an image would graphically disappear from the top object 10 and appear on the bottom object 10. It is also possible to have two objects interacting on different planes of motion. A user can place an object vertically on another, horizontally orientated object resulting in a different stack arrangement. The system architecture shown in FIG. 43 relating to such differing plane orientations follows a similar process flow to what was described above for FIG. 42. Visual or auditory feedback would accompany this location data action to confirm the system's response to the user. Object A could be used to divide the image displayed on object B to allow the parts of the image to be transferred to other objects. For example, a pizza displayed graphically on object B could be virtually divided into multiple slices such that subsequent adjacency events between object B and other objects would result in the pizza slices being graphically displayed on the other objects. Another example is a game in which users would compete to place their objects on top of a common object. The user whose object completes the location data action first would be proclaimed the winner of that round. In another example chemical compositions can be manipulated by “breaking” molecular bonds between elements. If the architecture supports the action the object would depict the new divided chemical compounds.

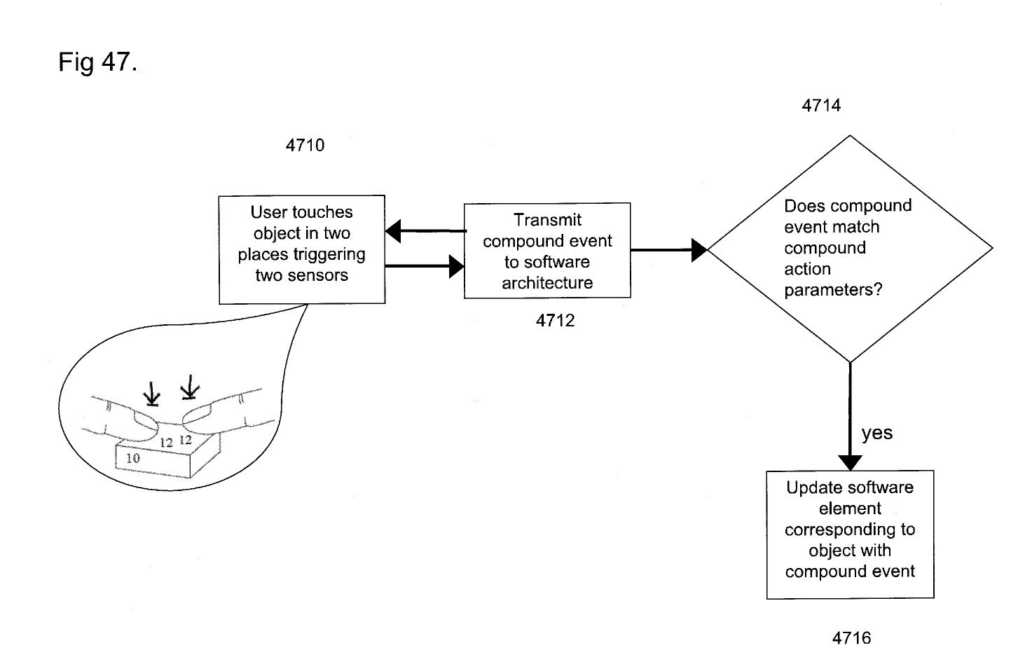

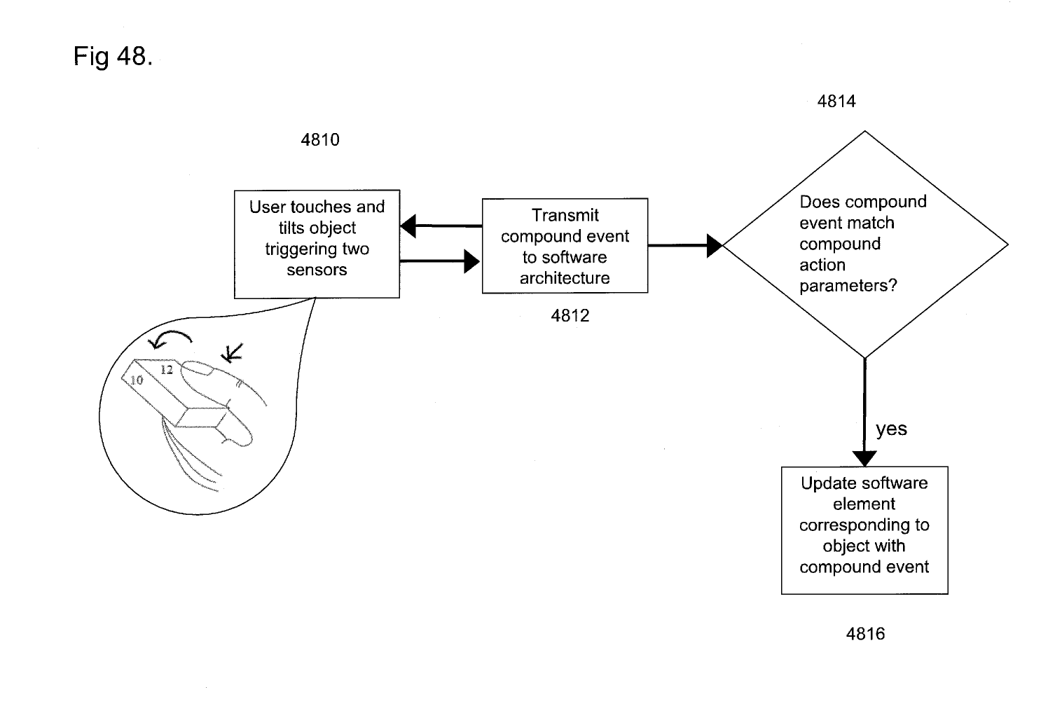

The physical action distributed user interface of the present invention can also result from single object compound actions. Examples of these types of actions are shown in FIGS. 44, 45 and 46. FIG. 44 depicts a user depressing multiple button sensor inputs 12 (both touch actions) on the single object 10 while FIG. 45 shows the user depressing a button or sensor while simultaneously tilting the object. Finally FIG. 46 depicts the user again depressing a sensor while simultaneously shaking the object. Identifying each of these single-objects, compound actions are described in FIGS. 47, 48 and 49 respectively. For example, when a user depresses multiple button sensors 4710 on an object 10 a compound event data is transmitted 4712 to the software architecture for analysis. The architecture determines 4714 whether the compound event data meets required parameters and, if so, the architecture updates 4716 the software elements corresponding to the object 10. This compound action combines two touch events described previously.

As one skilled in the relevant art will recognize the software architecture of the present invention can analyze and classify multiple touch events so as to properly characterize and initiate an appropriate response. In this case the event can be used for selection of multiple graphics on a display. For example, in a matching game, users could select two matching images from a multitude of images displayed graphically on the same object 10. Another example could be the same “Whac-a-mole™” type game described above, except with multiple mole holes displayed on a single object 10. This configuration would also allow multiple users to play simultaneously on one object 10 and allow users to use more than one finger to interact with the touch display.

Another example of a compound touch event on a single object is the combination of a touch with tilting the object. One application of this motion would be games that utilize guidance of the trajectory of a graphical object. A more specific implementation of this could be a bowling game in which users touch the object 10 to virtually release a bowling ball and tilt the object 10 to guide the ball's path down the alley.

Another example of the same type of trajectory-controlled interaction could be a dart game where users touch to graphically throw a dart and tilt to guide it to the bull's-eye on a virtual dartboard. Similarly the compound action could be a skateboarding game where users are able to virtually perform a variety of skateboarding tricks. The touch and tilt event could be a way to virtually jump onto different obstacles with the skateboard (touch event) while changing balance and direction on the skateboard (tilt event).

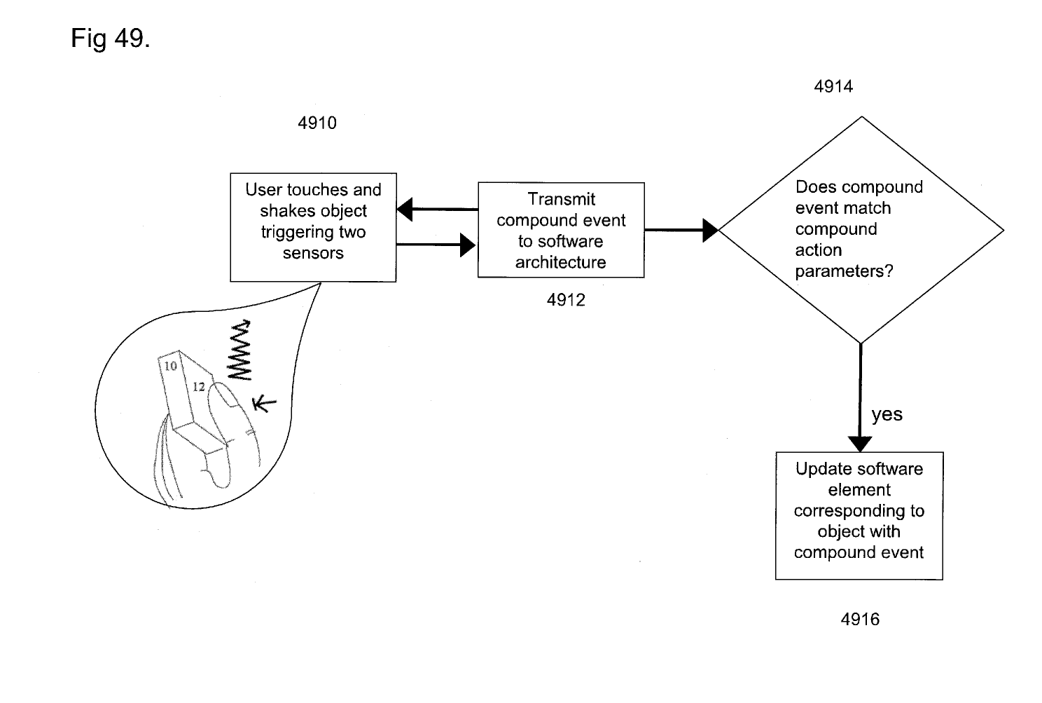

The process of such a compound action is shown in FIG. 49. Shaking the object while the user depresses pushbutton sensor input 12 (touch action) is also a single object compound action. As the user depresses a button sensor on object 10 while simultaneously shaking 4910 the object 10, compound event data is transmitted 4912 to the software architecture. The architecture determines whether the compound event data meets 4914 required parameters and when those parameters have been met the architecture updates 4916 the software elements corresponding to object 10. Compound events allow for a greater number of possible user actions even when the resulting action may be possible with a single action. For example, in a word scramble game in which one letter is displayed on each object 10, simply inciting a shake event might change the letter that is displayed on that particular object 10. In the same game, however, the compound event of touching and shaking simultaneously could change the letters displayed on all of the objects 10.

Another example is the interaction of virtually rolling dice. With dice graphically displayed on an object 10, the compound event can signify the user's roll of the dice. Graphical and auditory feedback could indicate to the user that the roll had been completed. This compound event could also be used as an advanced combination move in a fighting game. Performing a sequence of simultaneous actions, such as touching and shaking, could allow a virtual character displayed on a different object 10 to perform special combination moves. Each of these single object compound actions may result in software behavior that differs from simply combining results of the constituent actions.

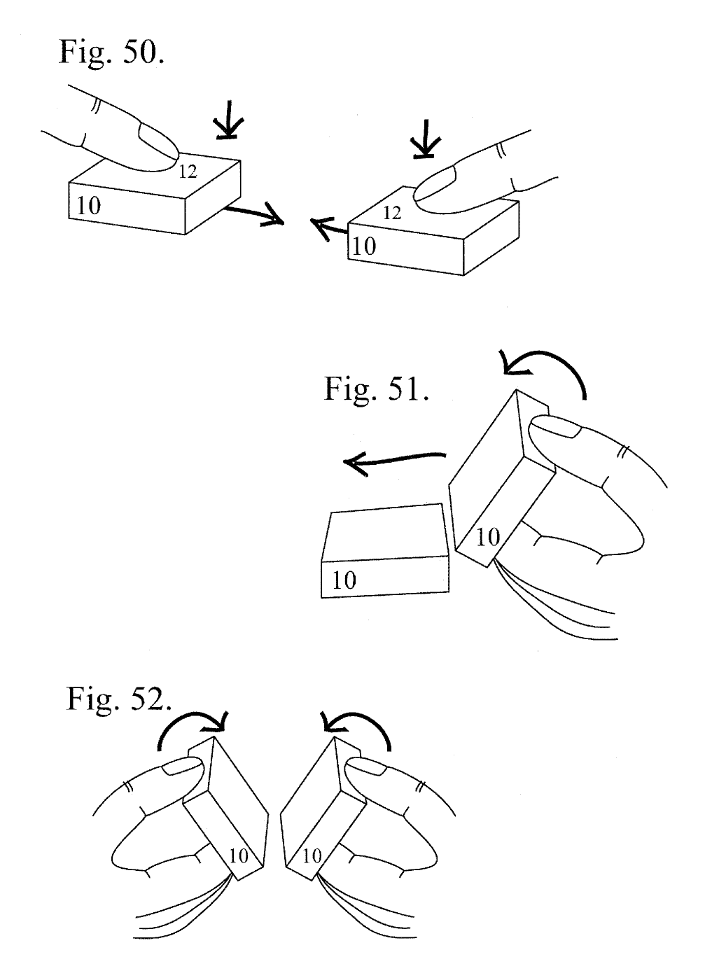

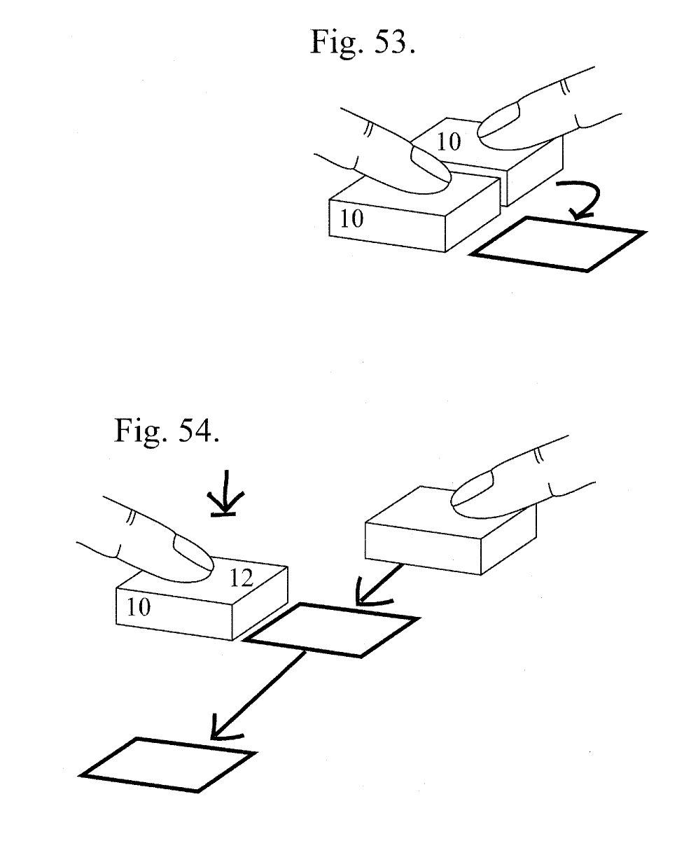

Another aspect of the present invention involves multi-object compound actions. Such actions are shown in FIG. 50-54. Each figure shows an example of a user interacting with the software system by executing multiple actions across multiple objects. In FIG. 50, for example a user is shown depressing a push button sensor input 12 (touch action) on two objects 10 while moving these objects 10 to positions adjacent to one another (motion action, arrangement action). FIG. 51 depicts a user moving an object 10 so as to be adjacent to another object 10 (arrangement action) while tilting this first object 10 (motion action). In FIG. 52 a user tilts two objects 10 towards one another (motion actions) and in FIG. 53, given a stationary object 10, a user is shown moving an adjacent object 10 away (motion action, arrangement action) and then to a different side of the stationary object 10 (arrangement action). Finally, FIG. 54 depicts a user depressing a pushbutton sensor input 12 on one object 10 (touch action) while moving another object 10 (motion action) to a position adjacent to the first object 10 such that they are adjacent (arrangement action), and then continuing past that object (motion action) such that they are no longer adjacent (arrangement action). Each of these examples describes a multiple object compound action which is recognized as a user interaction according to the present invention.

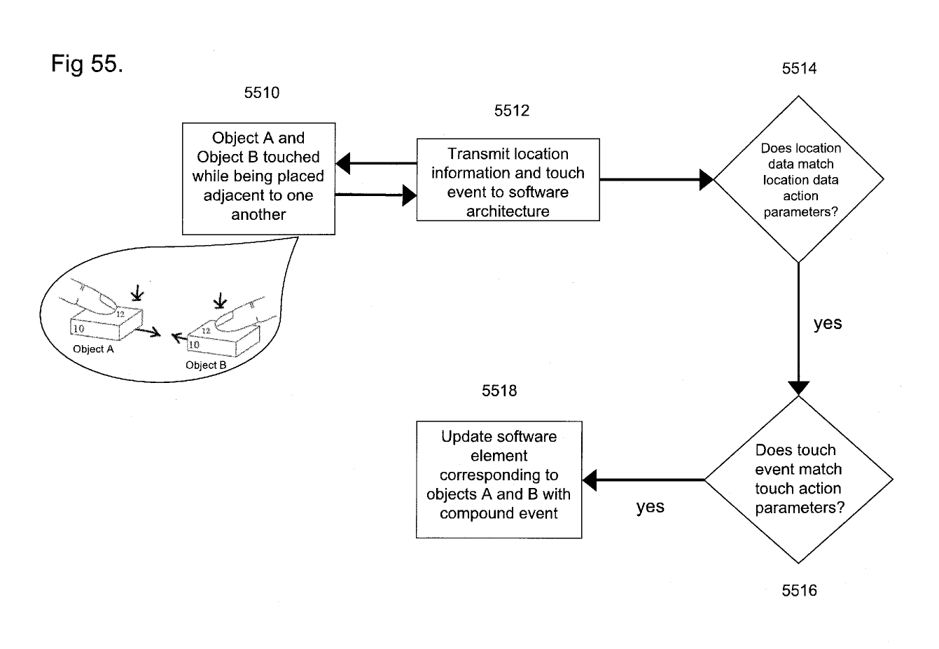

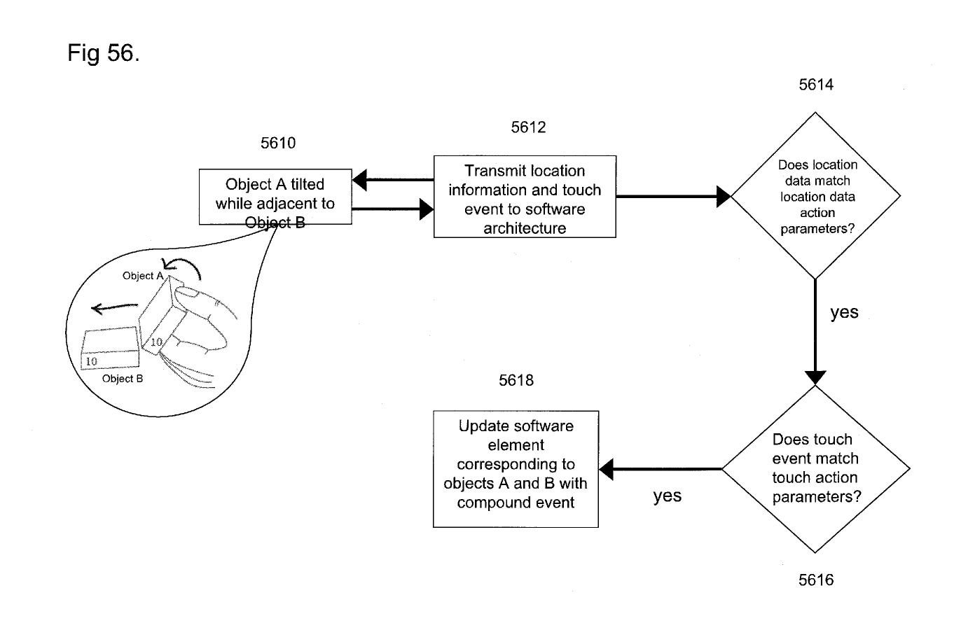

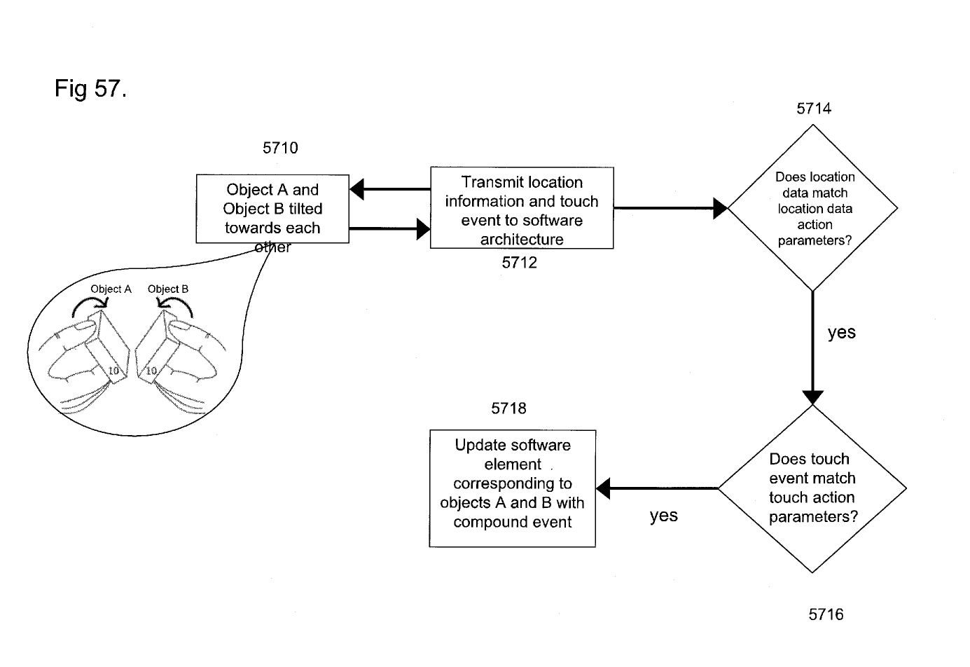

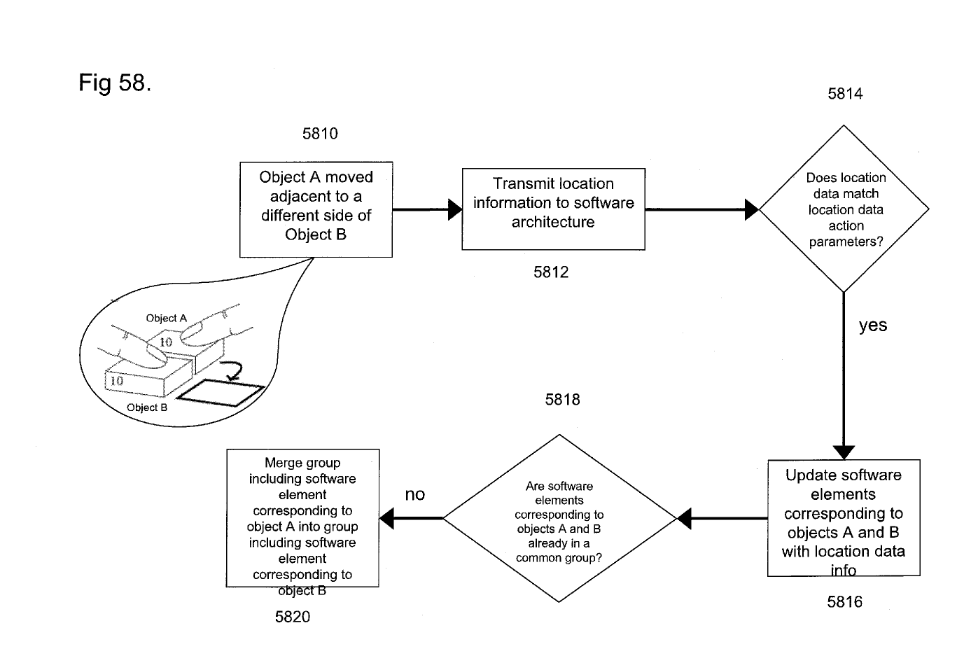

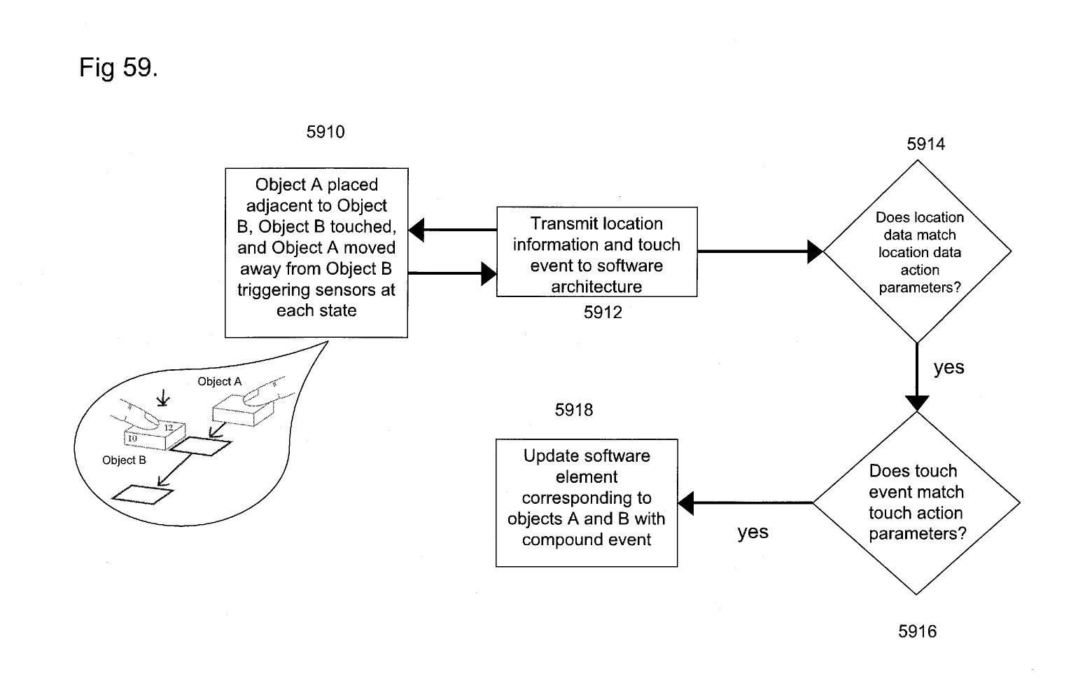

FIGS. 55-59 are flowcharts describing the process by which multi-object compound actions are conveyed to the software architecture, the data action parameters are verified and the software element for each respective object updated. FIGS. 55-59 refer respectively to the multi-object compound actions shown in FIGS. 50-54. Each begins with a compound action involving multiple objects 5510, 5610, 5710, 5810, and 5910. For example in FIG. 55, the user depresses the button sensors on object A (10) and object B (10) while placing them adjacent 5510 to one another. Compound event data is transmitted 5512, 5612, 5712, 5812, and 5912 to the software architecture which thereafter determines whether the compound event data meets location data parameters 5514, 5614, 5714, 5814, and 5914 and touch action parameters 5516, 5616, 5716, 5816, and 5916. When the compound data action and touch action parameters are met the architecture updates 5518, 5618, 5718, 5818, and 5918 the software elements corresponding to the involved objects, in this case objects A and B.

Examples of a multi-object compound action include causing a virtual vehicle or character to experience a boost of energy or speed. The touch event on one object 10 could graphically and audibly begin to activate a speed boost and the adjacency event with another object 10 with a spaceship displayed on it could cause the image of a spaceship to appear to move faster through space.

Another example is a “tangram” game that could display the shadow of a larger shape on one object 10 and display smaller shapes on another object 10. The user could be given the task of virtually arranging the smaller shapes to fit into the larger one. The press and adjacency event could act to select the desired smaller shape and graphically place it within the larger shape. Examples of a multi-touch compound action involving a tilting motion as shown in FIG. 51 include virtually pouring paint colors displayed on the objects 10. With a blue color displayed on one object 10 and a yellow paint bucket displayed on another object 10, the object 10 with the yellow paint bucket could be tilted when adjacent to the object 10 with the blue color to graphically change the display on that object 10 from a blue color to a green color. Although not used in this instance, graphical changes could be made to the displays on both objects 10 from this type of compound event. For example, the gopher in the maze previously described could virtually move between locations on the trail by tilting the object 10 with the gopher displayed on it adjacent to an object 10 with an empty portion of trail displayed. The resulting effect could be the gopher graphically disappearing from the object 10 being tilted and appearing on the adjacent object 10.

In the compound action depicted in FIG. 52 a user tilts two objects 10 towards one another (motion actions). One example of this type of compound action and its interaction with the software architecture is an image of a butterfly's wings displayed on each object 10. Repeating the motion of tilt and adjacency events could cause the butterfly to virtually fly. Notice that this event covers tilt events in any direction as long as the tilt event occurs between adjacent objects 10. For example, this event could allow for control in a 3-dimensional plane. Using the two objects 10 as controllers, a user could change the orientation with which an object is displayed on another object 10. Tilting the objects 10 could change different viewing axes of the object to allow for finer control of the viewing angle.

FIG. 53 shows two adjacent objects wherein one is and wherein the other adjacent object 10 is moved away (motion action, arrangement action) to a different side of the stationary object 10 (arrangement action). This type of compound action can be used to identify the virtual layout of an area. With a maze application, a user could place two objects 10 horizontally adjacent to one another to virtually reveal a portion of a path. However, when one of those objects 10 is moved to be vertically adjacent to the other object 10, a different portion of the path could be graphically shown. Another example could be a game in which users must match colors on different objects 10. One object 10 could display a different colored line on each of its sides, while another object 10 could have a dynamic display that changes which one of those colors is displayed at a given time. The user must place the latter object 10 adjacent to the side of the former object 10 such that the color on the latter object 10 matches the colored line displayed on the former object 10. In order to achieve this, the user could initiate the aforementioned motion and arrangement event and receive graphical and auditory feedback on the success of such an action.

Another multi-object compound action contemplated by the present invention and shown in FIG. 54 occurs when a user depresses pushbutton sensor input 12 on one object 10 (touch action) while moving another object 10 (motion action) to a position adjacent to the first object 10 such that they are adjacent (arrangement action), and then continuing past (motion action) such that they are no longer adjacent (arrangement action). This type of compound action can be used to graphically change the display on object A and/or object B to represent an interaction between the two images displayed. If a car is graphically represented on object A and a gas pump is graphically represented on object B, this event could cause the car to virtually fill its gas tank. By executing a motion action, the user could cause the car's wheels to virtually turn while s/he moves object A adjacent to object B. Touching object B could cause the car's gas tank on object A to virtually fill up, and when the user ends the adjacency event, the gas tank displayed on object A could now be full.

Another example is an action game in which a virtual character collects items. The collected items could all be graphically shown on object B. When a user wants to use one of these items, s/he could move the virtual character displayed on object A to be adjacent to object B, touch object B to virtually use one of the items, and then continue motion past object B to continue playing the game. This event could cause the virtual character to have increased skill or power to battle an upcoming enemy, for example.

There are several ways of implementing the architecture's detection of the described single and multi-object compound actions. In a temporal detection model, individual actions that occur together within a certain amount of time are considered by the architecture to be part of a compound action. For instance, when a button press and adjacency (motion) action occurs within 500 milliseconds of each other, these individual actions can be grouped into a single compound action. The specific timing constraints can be tuned to match the application and user audience. In a grammar-based model, individual actions occur in specific patterns that are matched against established action templates. A hybrid temporal-grammatical model combines these approaches, matching detected actions against templates, but with certain maximum tolerances for delay between actions that are treated as simultaneous and actions that are detected as sequential. Other embodiments can use alternative approaches for detecting compound actions.

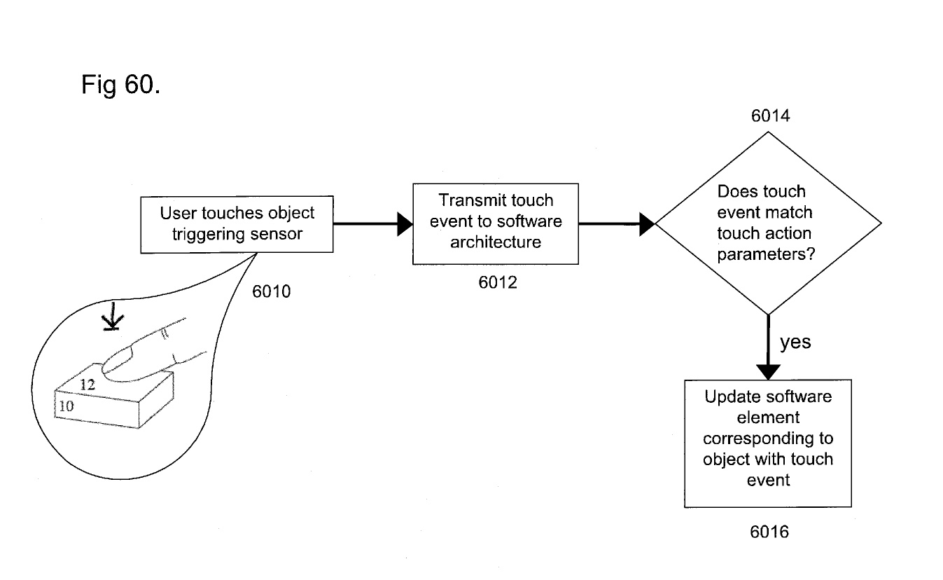

FIG. 60 depicts one embodiment or an implementation of how the software architecture handles a specific user action, in this case a touch event, for example, as first depicted in FIG. 5. As with the other flowcharts presented herein FIG. 60 serves only as an example of how the software architecture operates; similar diagrams apply to all the actions described in this document and to other like actions not described here. In this case, touching an object creates an event 6010 that is transmitted 6012 to the software architecture which then determines 6014, based on parameters described in the previous paragraph, if this touch event corresponds to a touch action. When the parameters are met the software architecture updates 6016 the software element corresponding to the object. A specific implementation of this type of interaction can include a physical tile with an integrated button and wireless radio. A user would press his finger against the screen, which generates a touch event on the device. This event is wirelessly transmitted to a host computer, on which elements of the software architecture reside. The architecture determines if the touch event corresponds to a touch action, by, for example, verifying that touch event was of a sufficiently long duration. At this point, the architecture updates a software element corresponding to the object 10. A software application using the architecture could thus be notified of this touch event, and change state accordingly. For example, it may advance the application to a new state that was represented graphically by a menu item shown on the display of the object 10, which could result in state updates to other objects including causing the object 10 to display a graphic providing visual feedback to the user that the system recognized the touch event.

Another example is in an application in which a question is presented to the user and the set of possible answers are displayed each on a single object 10; by pressing on a single object 10 the user can indicate their desired answer and the system may provide feedback about this choice such as feedback (graphical, auditory) about whether the selection was correct. Another example is in a “Whac-a-mole™” game in which the user must press the object 10 within a certain amount of time after a specific graphical feedback is presented on the display on object 10. If the touch event is detected within the given time window, graphical feedback may be presented on the display of object 10.

In other embodiments of the present invention, elements of the software architecture can reside in the objects themselves. The data structures and the information related to the various objects can be distributed among the various objects and an action based on a combined arrangement or compound action involving multiple objects determined in a coordinated and distributed fashion by the various objects. In one embodiment of the present invention a particular object may be elected by the participating objects to act as a coordinator. The role of the coordinator object may be assigned to any particular object and determined dynamically. Each object is equipped with the computational resources to be able to perform the above processing. In another embodiment there may be no elected coordinator object and each active object may compute the processing in parallel with the other objects. In a hybrid approach the software architecture may be partly executed by the objects and partly by a host machine separate from the objects. In a wholly distributed design the software architecture can be implemented on the objects themselves wherein the objects report events to the other objects and the objects tabulate these events. When an object determines that it has received the correct set of events for a particular action it can process that event and act on the action by, for example, sending a message to update the state of the other objects.

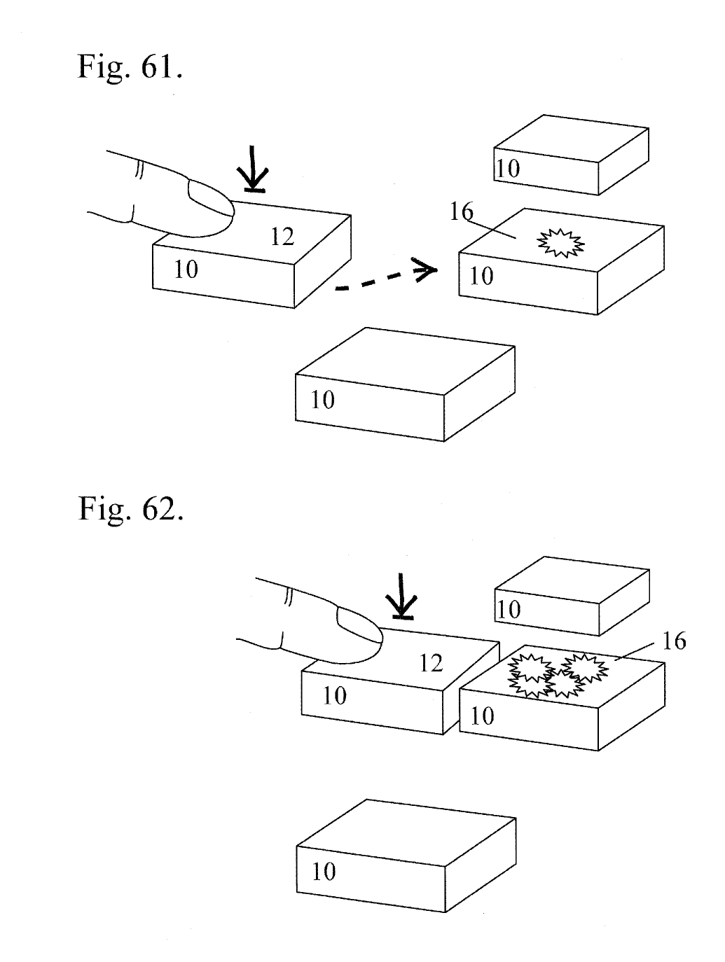

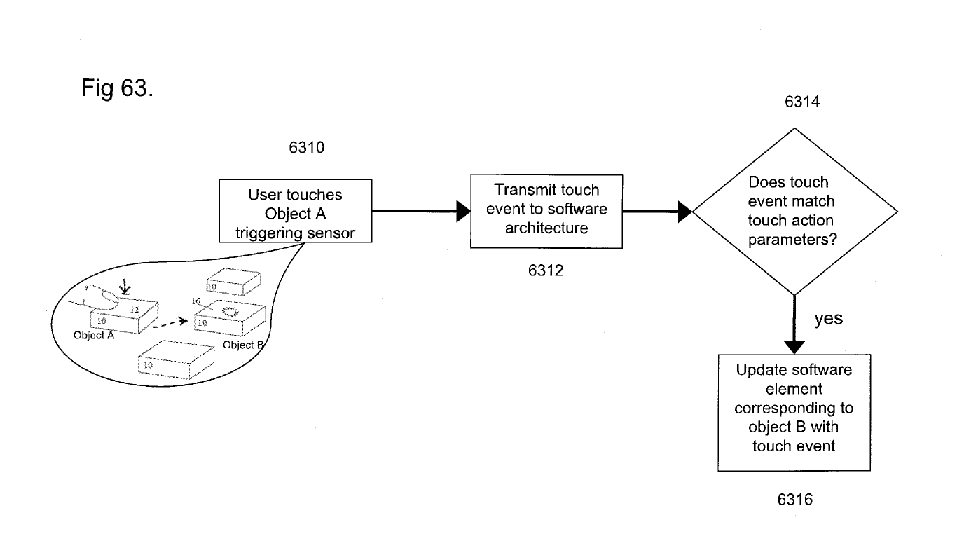

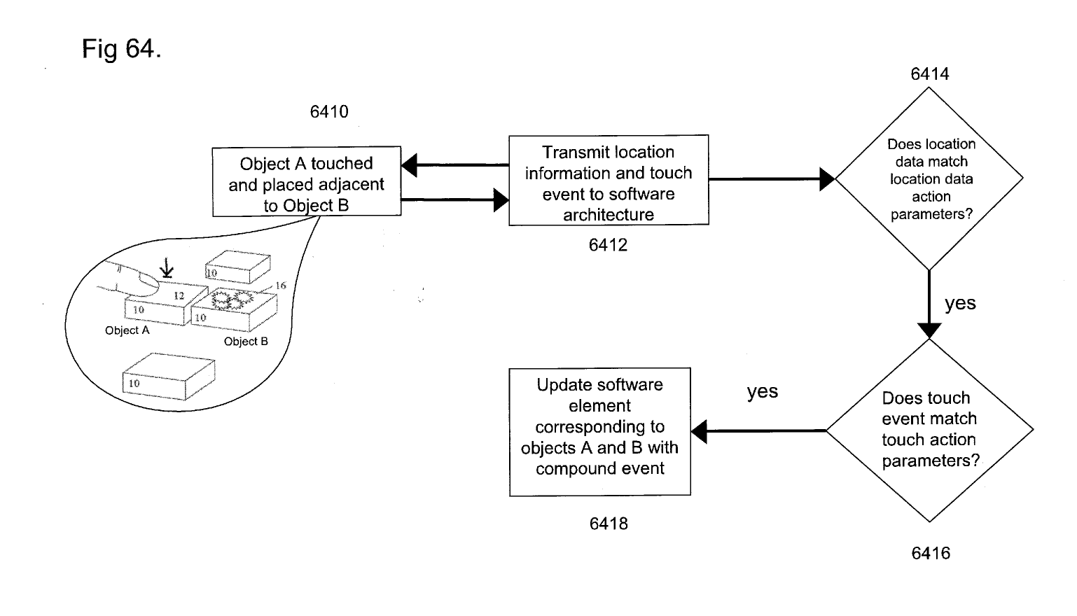

Some embodiments of the present invention include extensions to the software configuration that provide visual, audio, tactile, or other sensory feedback to the user in order to prompt or confirm user behavior. These extensions include but are not limited to initiating, continuing, or completing further actions or compound actions. For example, in FIG. 61, given a set of objects 10, a user is shown depressing one pushbutton sensor input 12, revealing a visual indicator on a display element 16 on a nearby object 10. This indicator prompts the user to move the object 10 s/he is currently depressing over to be adjacent to the indicated object 10 (arrangement action). In FIG. 62, with the arrangement action complete, the visually indicated object 10 shows confirmation via visual display 16. FIGS. 63 and 64 show a flowchart of the methodology for these actions.

The process shown in FIG. 63 begins 6310 with a user touching 12 an object A (10). This touch event can be transmitted 6312 to the software architecture. The software architecture thereafter determines 6314, based on parameters described in the previous paragraph, whether this touch event corresponds to a touch action. When a touch action has been declared the software architecture updates 6316 the software element corresponding to object B (10). In the process shown in FIG. 64, the user places object A (10) adjacent to object B (10) while touching object A (10), 6410. The compound event data is transmitted 6412 to the software architecture where again the architecture determines 6414 whether the compound event data meets required parameters. When the parameters have been met the architecture updates 6416 the software elements corresponding to object B, 6418.

One example of this is a trivia game in which object A displays a question. Touching object A could cause a hint to display on object B, but moving object A adjacent to object B could cause the display on object B to change from a hint to the correct answer. Another example is in an adventure game where this event could cause the virtual character to take a certain action. In this case, object A has the character displayed virtually on top of an object that could initiate an action for the character. Touching object A in this circumstance can cause object B to display a question of whether or not the user wants to take that action. The adjacency event can also act as confirmation of the user's choice to take the specified action.

In each of the above object/user interactions an object is touched or moved by a user such that data is transmitted to the software architecture for analysis. In some cases the interaction is a touch to a surface of the object and in others the interaction is the movement of an object relative to another object or the object's orientation. In each case the software architecture analyzes the data to determine whether action parameters have been met so as to determine whether the state of the object should be updated.

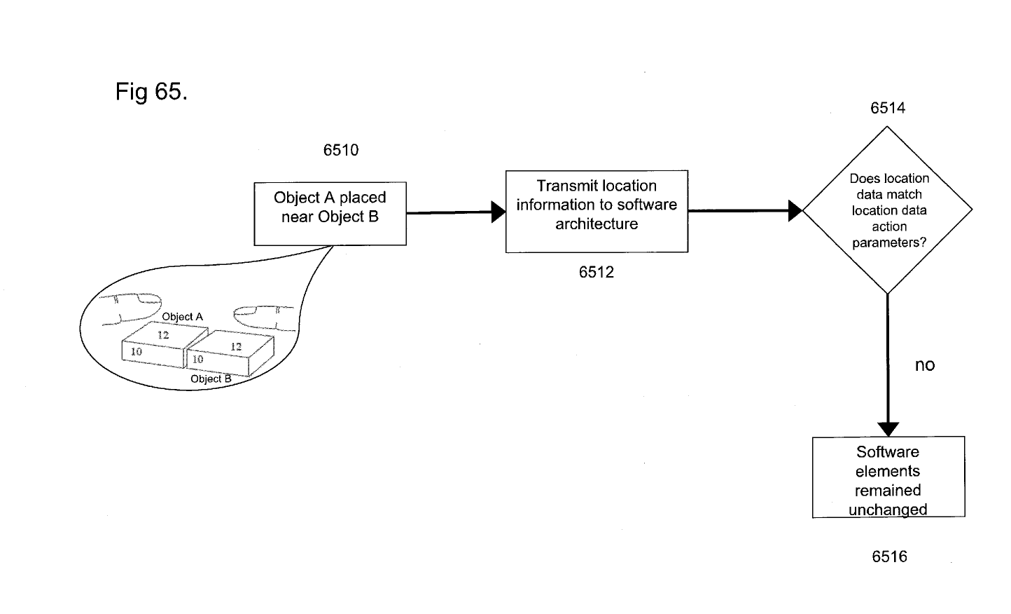

FIG. 65 depicts a flowchart of a process location information analysis due to user interaction originally shown in FIG. 3. In this case two objects are moved 6510 near to, but not adjacent to one another. The location information is transmitted 6512 to the software architecture for analysis and for determination of whether the location data matches 6514 predetermined location data action parameters. Unlike the previous examples, but consistent with the software architectures' analysis of the data presented to it by the objects of the present invention, the architecture determines that the location data does not match the location data parameters. When there is no match the state of the software elements remains unchanged 6516.

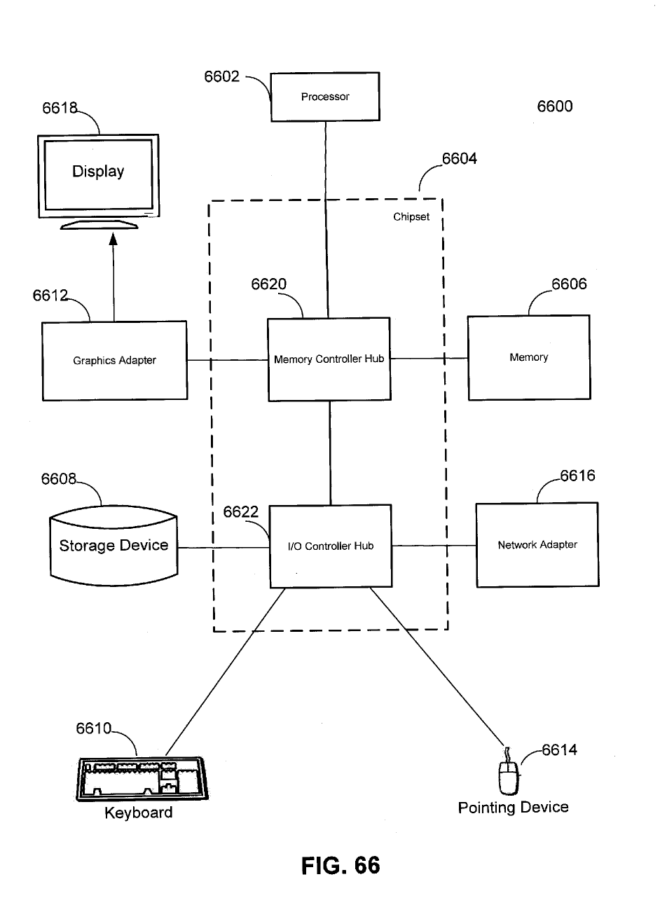

FIG. 66 is a high-level block diagram illustrating an example computer 6600 that can be used to implement the software system described herein. The computer 6600 includes at least one processor 6602 coupled to a chipset 6604. The chipset 6604 includes a memory controller hub 6620 and an input/output (I/O) controller hub 6622. A memory 6606 and a graphics adapter 6612 are coupled to the memory controller hub 6620, and a display 6618 is coupled to the graphics adapter 6612. A storage device 6608, keyboard 6610, pointing device 6614, and network adapter 6616 are coupled to the I/O controller hub 6622. Other embodiments of the computer 6600 have different architectures.

The storage device 6608 is a non-transitory computer-readable storage medium such as a hard drive, compact disk read-only memory (CD-ROM), DVD, or a solid-state memory device. The memory 6606 holds instructions and data used by the processor 6602. The pointing device 6614 is a mouse, track ball, or other type of pointing device, and is used in combination with the keyboard 6610 to input data into the computer system 6600. The graphics adapter 6612 displays images and other information on the display 6618. The network adapter 6616 couples the computer system 6600 to one or more computer networks.

The computer 6600 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 6608, loaded into the memory 6606, and executed by the processor 6602.

The types of computers 6600 used can vary depending upon the embodiment and requirements. For example, a computer system used for implementing the logic of a distributed tangible user interface may have limited processing power, and it may lack keyboards, and/or other devices shown in FIG. 66. A computer system that can receive signals from distributed tangible user interface to process the actions can be a desktop computer that is relatively more powerful compared to a computer in a distributed tangible object.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

An exemplary system for implementing the invention includes a general purpose computing device in the form of a conventional personal computer, a personal communication device or the like, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk and/or a magnetic disk drive for reading from or writing to a removable magnetic disk. The hard disk drive and magnetic disk drive are connected to the system bus by a hard disk drive interface and a magnetic disk drive interface respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer, such as magnetic cassettes, flash memory cards, digital video disks, random access memories (RAMs), read-only memories (ROMs) and the like may also be used in the exemplary operating environment.

A number of program modules may be stored on the hard disk, magnetic disk, ROM or RAM, including an operating system, one or more application programs or software portions, other program modules and program data. A user may enter commands and information into the personal computer through input devices such as a keyboard and pointing device. Other input devices may include a microphone, joystick, game pad, satellite dish, scanner or the like. These and other input devices are often connected to the processing unit through a serial port interface that is coupled to the system bus, but may be connected by other interfaces, such as a parallel port, game port or universal serial bus (USB). A monitor or other type of display device may also connect to the system bus via an interface, such as a video adapter.

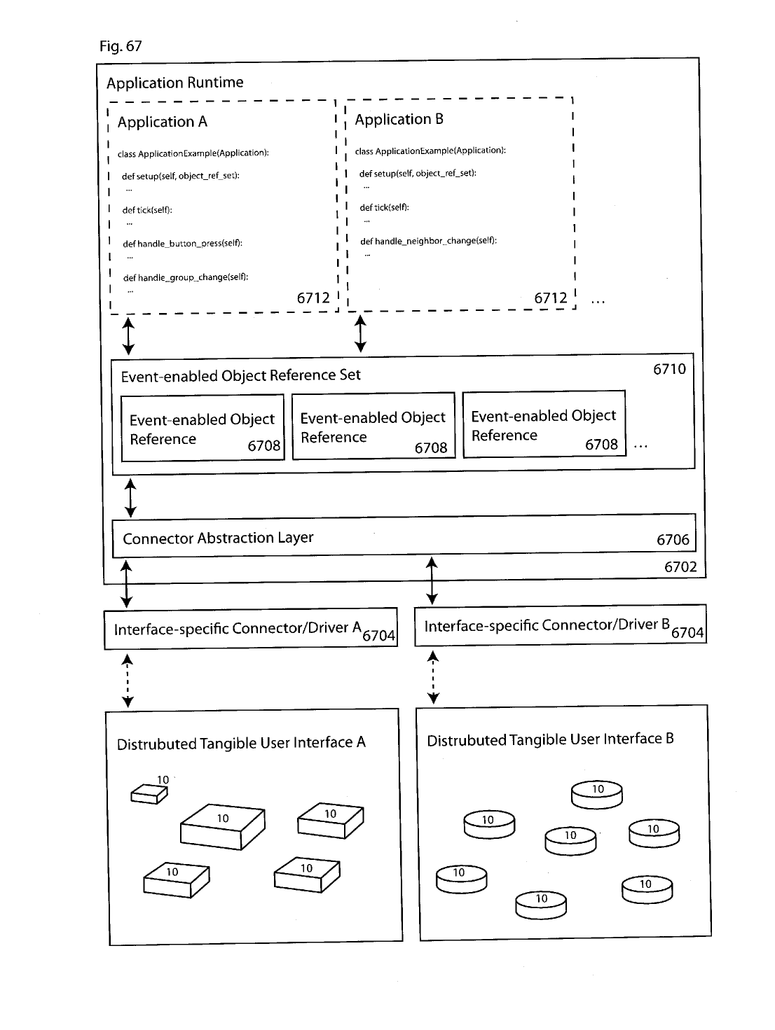

FIG. 67 is a block diagram illustrating the main parts of a software architecture application runtime 6702 according to one embodiment of the present invention. The depicted software architecture is capable of handling different types of distributed tangible user interfaces composed of different types of objects 10. These objects 10 communicate with a specific driver 6704. The software architecture abstracts these drivers into a general purpose connector software object 6706. This connector 6706 connects the physical objects 10 with software representations of or references to, these objects, 6708. These software representations are aggregated into a set of software elements 6710, which are exposed to a programmer, who can use these elements in an application 6712.

There are several advantages to the disclosed software designs. For example, the disclosed design offers a complete, generalizable methodology and implementable solution to incorporating and handling single and multi-object actions and gestures within a multi-object distributed tangible interface. In addition, the disclosed software designs support implementing program behavior triggered by not only single actions (including but not limited to click, shake, tilt, or group), but more sophisticated compound actions, making it possible for the software developer using a distributed tangible user interface to create programs that users will find more intuitive, engaging, and expressive. Further, the disclosed software designs extend to multi-object distributed tangible user interfaces of various forms, functions, and implementations, and offer a consistent grammar of patterns and actions that will enable developers and designers to create software utilizing such interfaces with greater speed and ease, while maintaining consistency across systems.

In a broad embodiment, a software system is configured to receive input from a distributed tangible user interface, thus detecting and handling user actions on single sensor inputs, as well as detecting and handling compound user actions involving multiple sensor inputs, on one object or across multiple objects, simultaneously, serially, or in combination, and with results of any such action wholly determined by the software code utilizing this system.

Some portions of this specification are presented in terms of algorithms or symbolic representations of operations on data stored as bits or binary digital signals within machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an interaction system for a distributed tangible user interface through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Claimable subject matter and additional written description includes, but is not limited to the following:

A software architecture that communicates with physical objects 10, each of which is equipped with inputs sensors and possibly outputs. The architecture provides an abstract software connector that allows the architecture to function with a variety of different types of objects 10. The architecture processes input events on these objects, classifies them and aggregates them into high-level user actions. These actions can be composed of events on one or more objects over time, and can be composed of arbitrarily complex compound sets of actions. These user actions generate software events that can be used by an application, allowing a programmer to more easily create applications that the user will find more intuitive and engaging.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

We claim:

1. A distributed tangible user interface method, comprising:
detecting a physical interaction with one or more physically manipulable objects;
determining whether the physical interaction matches a predefined action parameter; and
responsive to the physical interaction matching the predefined action parameter, updating one or more software elements corresponding to the one or more physically manipulable objects.

2. The method as recited in claim 1, wherein each object includes a plurality of sensors operative to detect the physical interaction of the one or more physically manipulable objects.

3. The method as recited in claim 1, wherein each of the one or more physically manipulable objects is independently manipulable relative to any other physically manipulable object.

4. The method as recited in claim 1, wherein each of the one or more physically manipulable objects includes a wireless communication device.

5. The method as recited in claim 1, wherein each of the one or more physically manipulable objects includes a feedback device suitable for rendering responsive feedback.

6. The method as recited in claim 1, wherein each of the one or more physically manipulable objects includes at least one movement sensor and a controller operable for receiving data from the at least one movement sensor and processing the data to derive movement parameters.

7. The method as recited in claim 1, wherein each of the one or more physically manipulable objects includes at least one proximity sensor and a controller operable for receiving data from the at least one proximity sensor and processing the data to derive proximity among the one or more physically manipulable objects.

8. The method as recited in claim 1, further comprising conveying the physical interaction to a software architecture.

9. The method as recited in claim 8 wherein a portion of the software architecture resides on a host computer apart from the one or more physically manipulable objects and another portion resides on the one or more physically manipulable objects.

10. The method as recited in claim 8, wherein the physical interaction is conveyed to the software architecture wirelessly.

11. The method as recited in claim 8, wherein the software architecture resides on a host computer apart from the one or more physically manipulable objects.

12. The method as recited in claim 8, wherein the software architecture is operable to process the physical interaction and implement a correspondence between the physical interaction and the software elements.

13. The method as recited in claim 1, wherein the physical interaction includes a touch event between a user and at least one physically manipulable object triggering a sensor.

14. The method as recited in claim 13, wherein the touch event is touching the at least one physically manipulable object.

15. The method as recited in claim 13, wherein the touch event is a touch release on the at least one physically manipulable object.

16. The method as recited in claim 13, wherein the touch event is a combined touch and release within a predetermined period of time on the at least one physically manipulable object.

17. The method as recited in claim 13, wherein the touch event is a surface touch and drag motion on the at least one physically manipulable object.

18. The method as recited in claim 13, wherein the touch event is a combined touch release touch within a predetermined period of time on the at least one physically manipulable object.

19. The method as recited in claim 13, wherein the touch event includes two or more simultaneous surface touches and drags on the at least one physically manipulable object.

20. The method as recited in claim 1, wherein the physical interaction includes a user imparting a motion event to at least one physically manipulable object triggering a sensor.

21. The method as recited in claim 20, wherein the motion event includes tilting the at least one physically manipulable object.

22. The method as recited in claim 20, wherein the motion event includes shaking the at least one physically manipulable object.

23. The method as recited in claim 20, wherein the motion event includes moving the at least one physically manipulable object within a single plane.

24. The method as recited in claim 20, wherein the motion event includes rotating the at least one physically manipulable object within a single plane.

25. The method as recited in claim 24, wherein the motion event includes flipping the at least one physically manipulable object.

26. The method as recited in claim 1, wherein the physical interaction includes a location altering event altering a location of at least one physically manipulable object with respect to at least one or more other physically manipulable objects triggering a sensor.

27. The method as recited in claim 26, wherein the location altering event includes moving two or more physically manipulable objects closer to each other and wherein upon achieving a predetermined proximity to each other and responsive to the two or more physically manipulable objects failing to be members of an existing common group, forming a new common group.

28. The method as recited in claim 26, wherein the location altering event includes moving one or more physically manipulable object closer to a common group of physically manipulable objects wherein the common group comprises a plurality of physically manipulable objects and wherein upon achieving a predetermined proximity between the one or more physically manipulable object and the common group and responsive to the one or more physically manipulable objects failing to be members of the common group, merging the one or more physically manipulable object to the common group.

29. The method as recited in claim 26, wherein the location altering event includes moving one or more physically manipulable object away from a common group of physically manipulable objects wherein the common group comprises a plurality of physically manipulable objects and wherein upon achieving a predetermined distance from the common group separating the one or more physically manipulable objects from the common group and forming a new common group in addition to the common group.

30. The method as recited in claim 1, wherein the physical interaction includes a compound event to at least one physically manipulable object triggering two or more sensors.

31. The method as recited in claim 30, wherein the compound event includes a plurality of touch events on a single physically manipulable device.

32. The method as recited in claim 30, wherein the compound event includes a touch event selected from the group consisting of a touch, touch release, combined touch and release, and combined touch release touch and a motion event selected from the group consisting of tilting, shaking, rotating, translating, and flipping said physically manipulable device.

33. The method as recited in claim 30, wherein the compound event includes a touch event selected from the group consisting of a touch, touch release, combined touch and release, and combined touch release touch and a location altering event altering a location of at least one physically manipulable object with respect to at least one or more other physically manipulable objects selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups.

34. The method as recited in claim 1, wherein updating includes changing a state of the one or more physically manipulable objects.

35. The method as recited in claim 1, wherein updating includes initiating user perceptible output by the one or more physically manipulable objects, by a host computer or by both the host computer and the one or more physically manipulable objects.

36. A computer-readable storage medium tangibly embodying a program of instructions executable by a machine wherein said program of instruction comprises a plurality of program codes for using a plurality of physically manipulable objects as an interface, said program of instruction comprising:
program code for detecting a physical interaction with one or more physically manipulable objects;
program code for determining whether the physical interaction matches a predefined action parameter; and
responsive to the physical interaction matching the predefined action parameter, program code for updating one or more software elements corresponding to the one or more physically manipulable objects.

37. The program of instructions embodied in the computer-readable storage medium of claim 36, wherein each of the one or more physically manipulable objects is independently manipulable relative to any other physically manipulable object.

38. The program of instructions embodied in the computer-readable storage medium of claim 36, wherein each of the one or more physically manipulable objects includes a wireless communication device.

39. The program of instructions embodied in the computer-readable storage medium of claim 36, wherein each of the one or more physically manipulable objects includes a feedback device suitable for rendering responsive feedback.

40. The program of instructions embodied in the computer-readable storage medium of claim 36, wherein each of the one or more physically manipulable objects includes at least one movement sensor and a controller operable for receiving data from the at least one movement sensor and processing the data to derive movement parameters.

41. The program of instructions embodied in the computer-readable storage medium of claim 36, wherein each of the one or more physically manipulable objects includes at least one proximity sensor and a controller operable for receiving data from the at least one proximity sensor and processing the data to derive proximity among the one or more physically manipulable objects.

42. The program of instructions embodied in the computer-readable storage medium of claim 36, further comprising program code for conveying the physical interaction to a software architecture.

43. The program of instructions embodied in the computer-readable storage medium of claim 36, further comprising program code for processing the physical interaction and implementing a correspondence between the physical interaction and the software elements.

44. The program of instructions embodied in the computer-readable storage medium of claim 36, wherein the physical interaction includes a touch event between a user and at least one physically manipulable object selected from the group consisting of a touch, touch release, combined touch and release, and combined touch release touch, said touch event triggering a sensor.

45. The program of instructions embodied in the computer-readable storage medium of claim 36, wherein the physical interaction includes a user imparting a motion event to at least one physically manipulable object, the motion event selected from the group consisting of tilting, shaking, rotating, translating, and flipping said physically manipulable device, said motion event triggering a sensor.

46. The program of instructions embodied in the computer-readable storage medium of claim 36, wherein the physical interaction includes a location altering event altering a location of at least one physically manipulable object with respect to at least one or more other physically manipulable objects, the location event selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups, said location event triggering a sensor.

47. The program of instructions embodied in the computer-readable storage medium of claim 36, wherein the physical interaction includes a compound event, wherein the compound event includes interaction with at least one physically manipulable object triggering two or more sensors.

48. The program of instructions embodied in the computer-readable storage medium of claim 47, wherein the compound event includes a plurality of touch events on a single physically manipulable device.

49. The program of instructions embodied in the computer-readable storage medium of claim 47, wherein the compound event includes a touch event selected from the group consisting of a touch, touch release, combined touch and release, and combined touch release touch, and a motion event selected from the group consisting of tilting, shaking, rotating, translating, and flipping said physically manipulable device.

50. The program of instructions embodied in the computer-readable storage medium of claim 47, wherein the compound event includes a touch event selected from the group consisting of a touch, touch release, combined touch and release, and combined touch release touch and a location altering event altering a location of at least one physically manipulable object with respect to at least one or more other physically manipulable objects selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups.

51. The program of instructions embodied in the computer-readable storage medium of claim 47, wherein the compound event includes a plurality of motion events on a single physically manipulable device

52. The program of instructions embodied in the computer-readable storage medium of claim 47, wherein the compound event includes a plurality of location-altering events on a single physically manipulable device

53. The program of instructions embodied in the computer-readable storage medium of claim 47, wherein the compound event includes a touch event selected from the group consisting of a touch, touch release, combined touch and release, and combined touch release touch and a motion event selected from the group consisting of tilting, shaking, rotating, translating, and flipping said physically manipulable device.

54. The program of instructions embodied in the computer-readable storage medium of claim 36, further comprising program code for changing a state of the one or more physically manipulable objects.

55. The program of instructions embodied in the computer-readable storage medium of claim 36, further comprising program code for triggering user perceptible output by the one or more physically manipulable objects.

56. A distributed tangible user interface system, comprising:
a plurality of physically manipulable objects wherein each object includes a plurality of sensors operative to detect a physical interaction with one or more physically manipulable objects;
a host computer communicatively coupled with each of the plurality of physically manipulable objects; and
a plurality of software portions, wherein one of said software portions is configured to determining whether the physical interaction matches a predefined action parameter and, responsive to the physical interaction matching the predefined action parameter, another one of said software portions is configured to update one or more software elements corresponding to the one or more physically manipulable objects.

57. The distributed tangible user interface system of claim 56, wherein each of the one or more physically manipulable objects is independently manipulable relative to any other physically manipulable object.

58. The distributed tangible user interface system of claim 56, wherein each of the one or more physically manipulable objects includes a wireless communication device.

59. The distributed tangible user interface system of claim 56, wherein each of the one or more physically manipulable objects includes a feedback device suitable for rendering responsive feedback.

60. The distributed tangible user interface system of claim 56, wherein each of the one or more physically manipulable objects includes at least one movement sensor and a controller operable for receiving data from the at least one movement sensor and processing the data to derive movement parameters.

61. The distributed tangible user interface system of claim 56, wherein each of the one or more physically manipulable objects includes at least one proximity sensor and a controller operable for receiving data from the at least one proximity sensor and processing the data to derive proximity among the one or more physically manipulable objects.

62. The distributed tangible user interface system of claim 56, wherein one of said software portions is configured to convey the physical interaction to a software architecture.

63. The distributed tangible user interface system of claim 62, wherein the software architecture is resident on the host computer.

64. The distributed tangible user interface system of claim 56, wherein one of said software portions is configured to process the physical interaction and implement a correspondence between the physical interaction and the software elements.

65. The distributed tangible user interface system of claim 56, wherein the update to the one or more software elements triggers a change of state of the corresponding one or more physically manipulable objects.

66. The distributed tangible user interface system of claim 56, wherein one of said software portions is configured to trigger a user perceptible output by the one or more physically manipulable objects.

67. The distributed tangible user interface system of claim 56, wherein the physical interaction includes a touch event between a user and at least one physically manipulable object selected from the group consisting of a touch, touch release, combined touch and release, and combined touch release touch, said touch event triggering a sensor.

68. The distributed tangible user interface system of claim 56, wherein the physical interaction includes a user imparting a motion event to at least one physically manipulable object, the motion event selected from the group consisting of tilting, shaking, rotating, translating, and flipping said physically manipulable device, said motion event triggering a sensor.

69. The distributed tangible user interface system of claim 56, wherein the physical interaction includes a location altering event altering a location of at least one physically manipulable object with respect to at least one or more other physically manipulable objects, the location event selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups, said location event triggering a sensor.

70. The distributed tangible user interface system of claim 56, wherein the physical interaction includes a compound event to at least one physically manipulable object triggering two or more sensors.

71. The distributed tangible user interface system of claim 70, wherein the compound event includes a plurality of touch events on a single physically manipulable device.

72. The distributed tangible user interface system of claim 70, wherein the compound event includes a touch event selected from the group consisting of a touch, touch release, combined touch and release, and combined touch release touch and a motion event selected from the group consisting of tilting, shaking, rotating, translating, and flipping said physically manipulable device.

73. The distributed tangible user interface system of claim 70, wherein the compound event includes a touch event selected from the group consisting of a touch, touch release, combined touch and release, and combined touch release touch and a location altering event altering a location of at least one physically manipulable object with respect to at least one or more other physically manipulable objects selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups.

74. A method for interacting with a computing device, comprising:
physically interacting with one or more of a plurality of physically manipulable objects wherein each of the plurality of manipulable objects possesses a state;
gathering physical interaction data from said physically manipulable objects;
communicating said physical interaction data to a software architecture;
determining whether the physical interaction data matches one or more predefined action parameters; and
responsive to the physical interaction data matching at least one of the one or more predefined action parameters, updating the state of the one or more physically manipulable objects.

75. The method as recited in claim 74, wherein interacting includes a touch event, a motion event, a location altering event altering a location of at least one physically manipulable object with respect to at least one or more other physically manipulable objects, or a compound event.

76. The method as recited in claim 75, wherein the touch event is selected from the group consisting of a touch, touch release, combined touch and release, and combined touch release touch.

77. The method as recited in claim 75, wherein the motion event is selected from the group consisting of tilting, shaking, rotating, translating, and flipping said physically manipulable device.

78. The method as recited in claim 75, wherein the location altering event selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups.

79. The method as recited in claim 75, wherein the compound event includes a touch event selected from the group consisting of a touch, touch release, combined touch and release, and combined touch release touch and a location altering event altering a location of at least one physically manipulable object with respect to at least one or more other physically manipulable objects selected from the group consisting of moving two or more physically manipulable objects closer to each other, moving one or more physically manipulable objects closer to a common group of physically manipulable objects either forming a new common group or merging into an existing common group, and moving one or more physically manipulable object away from a common group of physically manipulable objects creating two or more separate groups.
